(19) United States
(12) Patent Application Publication
(10) Pub. No.: US 2025/0326693 A1
(43) Pub. Date: Oct. 23, 2025

(54) METHOD AND DEVICE FOR PRODUCING CERAMICS AND CERAMIC PRODUCT

(71) Applicant: TECHNISCHE UNIVERSITÄT DARMSTADT, Darmstadt (DE)

(72) Inventors: Lukas PORZ, Darmstadt (DE); Wolfgang RHEINHEIMER, Jülich (DE); Michael SCHERER, Darmstadt (DE)

(21) Appl. No.: 18/281,187

(22) PCT Filed: Mar. 11, 2022
(86) PCT No.: PCT/EP2022/056389

§ 371 Date: Mar. 29, 2024

(30) Foreign Application Priority Data
Mar. 12, 2021 (DE) 102021106117.2
Nov. 19, 2021 (DE) 102021130349.4

(51) Int. Cl. C04B 35/468; B01D 71/02; B01J 6/00; C04B 35/46; C04B 35/64

(52) U.S. Cl. CPC C04B 35/4682; B01D 71/024; B01J 6/005; C04B 35/46; C04B 35/64; C04B 2235/3232; C04B 2235/3236; C04B 2235/6562; C04B 2235/6567; C04B 2235/667

(57) ABSTRACT

The present invention relates to a method and a device for producing ceramics, the method comprising: radiating light onto a ceramic starting material in order to heat this at least in some regions and, as a result, to produce a ceramic product, wherein the radiation of light is carried out simultaneously on a surface of at least 0.1 mm² and/or more than 20% of the surface of the ceramic starting material, and wherein the power density of the radiated light is less than 800 W/cm², the device comprising: —at least one receiving means for receiving a ceramic starting material and—at least one light source for radiating light onto the ceramic starting material that is or can be received in the receiving means, the device preferably being configured to radiate the light onto the ceramic starting material in order to heat this at least in some regions and, as a result, to produce a ceramic product, and wherein the receiving means has an insulation.

### CROSS-REFERENCE TO RELATED APPLICATION

This application is U.S. national phase under 35 U.S.C. § 371 of International Patent Application No. PCT/EP2022/056389, filed on Mar. 11, 2022, which claims priority to German Application Number 102021106117.2, filed on Mar. 12, 2021 and German Application Number 102021130349.4, filed on Nov. 19, 2021, the contents of all of which are incorporated by reference in their entirety.

The present invention relates to a method and a device for producing ceramics.

### STATE OF THE ART

From the state of the art, it is known to regularly produce ceramics from ceramic powder aggregated by sintering. During sintering the temperature is increased causing the components of the powder to become aggregated to form the finished ceramics. To that end, typically, the powder is heated in sintering furnaces to create the ceramics. This also applies to so-called functional ceramics. These fall into a special class of ceramic materials that have specific technical properties.

Producing ceramics by densifying ceramic powder by means of sintering at high temperatures requires, in particular, temperature-resistant furnaces and a high energy input as well as extended process times. Furnaces are constructed from highly temperature-resistant materials and heated at high expenditure of energy. Hereby, the ceramics heats up in the interior of the furnace, thereby carrying out the sintering process. The temperature resistance of even these furnaces is limited, however, so that sometimes recourse has to be made to sintering adjuvants (for example, when using Si₃N₄) to lower the sintering temperature. Generally, the process times require hours, and much energy is required.

Therefore, there still exists the desire to make ceramics and its production more efficient.

It is, therefore, the object of the present invention to specify a method and a device by means of which the disadvantages of the state of the art can be overcome, and which allow, in particular, more efficient ceramics to be produced. Furthermore, it is an object of the present invention to specify a ceramic product which overcomes the disadvantages of the prior art.

### DESCRIPTION OF THE INVENTION

The task is solved by the invention according to a first aspect in that a method for producing ceramics (with or without dislocations) is proposed, the method comprising: radiating light onto a ceramic starting material in order to heat the same at least in some regions and, as a result, to produce a ceramic product, wherein the radiation of light is carried out simultaneously, i.e. at the same time, on a surface of more than 20% of the surface of the ceramic starting material, wherein the power density of the radiated light lies between 10 W/cm2 and 750 W/cm2, further preferably between 20 W/cm2 and 200 W/cm2, where the light comprises wavelengths in a range between 200 and 700 nm, and where the ceramic starting material is thermally isolated from a receiving means by means of an insulation.

Radiating of light can happen, for example, simultaneously onto more than 20%, onto at least 35%, at least 50%, at least 65%, at least 80%, at least 90%, at least 95%, or at least 99% of the surface of the ceramic starting material, in particular, onto the entire surface.

Radiating of light can happen, for example, simultaneously onto a surface of at least 0.1 mm², at least 0.2 mm², at least 0.5 mm², at least 0.01 cm², at least 0.02 cm², at least 0.05 cm², at least 0.1 cm², at least 0.2 cm², at least 0.5 cm², or at least 1.0 cm², in particular, onto at least 60%, at least 70%, at least 80%, at least 90%, at least 95%, at least 98%, or at least 99% of the surface of the ceramic starting material, for example, onto the entire surface.

Radiating of light happens, in particular, for a time period of at least 0.1 seconds, at least 0.5 seconds, at least 1 second, preferably at least 5 seconds, preferably at least 20 seconds, and/or a maximum of 10 minutes, preferably maximal 8 minutes, preferably maximal 5 minutes, preferably a maximum of 3 minutes, preferably a maximum of 1 minute, preferably a maximum of 30 seconds, preferably a maximum of 10 seconds. Radiating of light at a power density of less than 800 W/cm² serves, in particular, the sintering of the solid body.

In addition to the above-described radiation of light, the method according to the invention may include a further step of radiating light onto the ceramic starting material at a higher power density for a significantly shorter period of time, so as to heat this material at least in some regions to thereby produce a ceramic product, where the radiation of light happens simultaneously, i.e. at the same time, onto more than 50% of the surface of the ceramic starting material, and where the power density of the radiated light is at least 800 W/cm², for example, at least 1000 W/cm², at least 2000 W/cm², at least 4000 W/cm², at least 10000 W/cm², at least 15000 W/cm², at least 50000 W/cm², or at least 400000 W/cm², preferably not more than 750.000 W/cm², not more than 20000 W/cm², not more than 8000 W/cm², not more than 10000 W/cm², not more than 7000 W/cm², or not more than 5000 W/cm².

The further step of radiating light happens, in particular, for significantly shorter periods of time, for example, not longer than 100 Milliseconds (ms), not longer than 50 ms, not longer than 40 ms, not longer than 30 ms, not longer than 25 ms, or not longer than 20 ms, and/or at least 0.5 ms, at least 1 ms, at least 2 ms, at least 5 ms, or at least 10 ms. In view of the short period of time, the further radiation of light may also be referred to as a flash of light.

The radiating of light in the further step may happen, for example simultaneously, onto at least 60%, at least 70%, at least 80%, at least 90%, at least 95%, at least 98%, or at least 99% of the surface of the ceramic starting material, in particular, onto the entire surface.

The radiating of light in the further step may happen, for example simultaneously, onto a surface of at least 0.1 mm², at least 0.2 mm², at least 0.5 mm², at least 0.01 cm², at least 0.02 cm², at least 0.05 cm², at least 0.1 cm², at least 0.2 cm², at least 0.5 cm², or at least 1.0 cm², in particular, onto at least 60%, at least 70%, at least 80%, at least 90%, at least 95%, at least 98%, or at least 99% of the surface of the ceramic starting material, for example, onto the entire surface.

Thus in a preferred embodiment, in addition to radiating for the sintering of the solid body, the surface is radiated stronger for a very short period of time before or after, preferably during the sintering process. For example, using a flash made of a Xe flash light, at a high power density (in particular, at least 800 W/cm², for example at least 1000 W/cm², at least 1500 W/cm², at least 2000 W/cm², at least 2500 W/cm², at least 3000 W/cm², at least 3500 W/cm², at least 4000 W/cm², or about 4350 W/cm²) for a short period of time (in particular, a maximum of 50 ms, a maximum of 40 ms, a maximum of 30 ms, a maximum of 25 ms, or a maximum of 10 ms, for example about 20 ms), it is possible to heat up the surface much stronger than the volume material lying underneath it. This creates a layer at the surface having different properties. This preferably comprises a texture and has a higher density and grain size than the solid body. Moreover, this layer can be used to generate directional grain growth in the solid body. In the English language this type of control over the grain growth is referred to as “templated grain growth.”

Preferably, thermal misfit or misfit by shrinkage between the layer and the solid body is reduced, in particular, prevented, by using the flash, while the solid body itself is at a high temperature, whereby the ceramic product can relieve tensions at high temperatures particularly well. By using light to heat the powder material it is possible, for one thing, to drastically reduce the process time and the energy consumption and, for another, to control, in particular, adjust and/or actively control, the parameter of heat rate with a high degree of reliability. This allows purposeful control over how quickly the powder is heated at what location. In particular, it is possible to carry out a heating simultaneously on a large surface, and the process can be realized as a continuous procedure. The ceramic material can be heated particularly quickly by way of illumination. Hereby, a high heating rate can be attained in the ceramic material at the radiated areas. Thus, the proposed method allows, in particular, a much more direct control over the power density and, therewith, the temperature in the ceramic material. At the same time, surprisingly, the method can be carried out much easier than the conventional ceramics production. At the same time, aspects can be realized which would be impossible or attainable only at particularly high expenditure in conventional sintering, in particular, one or more of the following aspects.
Creating a grain size gradient,
Creating a texture,
Creating nano porosity,
Creating an improved temperature resistance, in particular, at particularly high temperatures,
Creating homogeneous material properties,
Reduction of the process time,
More exact controllability of the process, in particular, realization of very rapid profiles,
Energy savings, in particular, in small batch series, even in the production of thicker ceramics, and/or
Acceleration, price reduction, simplification of development, in particular, as regards small batches.

A grain size gradient and/or a texture can be created by means of different temperature profiles on the surface and in the interior of the ceramic product. For example, the method may include a temporal and/or spatial power density profile. A preferred temporal power density profile includes, for example, one power density in a range between 800 W/cm² and 20.000 W/cm², for example, 4350 W/cm², for a period of time of between 0.2 and 200 ms, for example, 20 ms, followed by or parallel with a further power density in a range between 10 W/cm² and 800 W/cm², for example 130 W/cm², for a period of time of between 1 second and 2 minutes, for example, 10 seconds. Hereby, a ceramic product can be created which has a grain size gradient and/or a texture. In particular, it is possible to obtain a ceramic product which has a porous volume underneath a densely sintered surface layer. Owing to the high initial power density the densely sintered surface layer is created. Due to the shortness of time during which the initial power density is utilized, the densely sintered layer is limited to a thin surface layer. The thickness of the surface layer may be, for example, in a range between 10 and 20 μm. Ceramic products with a dense surface layer and a porous volume underneath are particularly suited for use in fuels cells. Grain size and texture each have an effect on the functional and mechanical properties such as, e.g., conductivity and vulnerability to cracking.

Using the method according to the invention even nano porosity can be created. Nano pores are pores having a Martin diameter of less than 1 μm, i.e., in the nanometer range, which can be quantified using micro structure analysis, i.e., for example, the evaluation of von TEM micrographs. A ceramic product according to the invention may contain nano pores. This is true, in particular, when the ceramic product includes TiO₂, BaTiO₃, YSZ (English: “Yttria-stabilized zirconia”) or Li_{0.3}La_{0.7}TiO₃ as a material.

Moreover, the method according to the invention allows sintering at extremely high temperatures, for example, at temperatures in a range between 500° C. and 3200° C., because there is no limitation of the maximum temperature by a furnace. This allows the produced ceramic products to attain an improved temperature resistance, in particular, at high temperatures of, for example, higher than 1400° C. The extremely high process temperatures allow dispensing with sintering adjuvants and to generate larger grains and, therewith, to attain an improved creep resistance. Depending on the primary diffusion path the creep rate is proportional to 1/grain size² (Nabarro-Herring creeping) or 1/grain size³ (Coble creeping). This opens up new use cases for ceramic products in which the utilization of conventionally produced ceramics is limited by their low temperature stability; it is possible for example, by a ten-fold increase of the grain size to increase a prolongation of the time up to which an undesired stretching level is not exceeded at equal temperature and tension by a factor 100 to 1000 and, therewith, prolong the period of service of the ceramic product by a similar amount.

Using the present method, in the ceramic starting material and/or in the ceramic product, in particular, s temperature of at least 1400° C., at least 1500° C., at least 1600° C., at least 1700° C., at least 1800° C., at least 1900° C., or at least 2000° C. is attained. The temperature in the ceramic starting material and/or the ceramic product may lie, for example, in a range between 500° C. and 3200° C., in particular, in a range between 1000° C. and 3000° C., 1200° C. and 2800° C., 1400° C. and 2700° C., 1500° C. and 2600° C., 1600° C. and 2500° C., 1700° C. and 2400° C., 1800° C. and 2300° C., 1900° C. and 2200° C., or of 2000° C. and 2100° C.

In a preferred embodiment the ceramics is heated up during the sintering process significantly higher to at least 1800° C. or even significantly higher, e.g., 2500° C. Hereby, for example, an insulation of exfoliated graphite is used. In particular, such an extremely high temperature can be attained without high technical efforts in a common atmosphere. This allows the making of materials with particularly coarse starting powder or with a particularly high sintering and melting temperature. This can accelerate, reduce in cost, and simplify the production of ceramics such as, e.g., silicon carbide, silicon nitride, boron carbide, carbide nitride, or magnesium oxide.

Using the method according to the invention ceramic products with significantly more homogeneous material properties can be generated, for example, as regards the grain size, phase composition, porousness, number and size of micro cracks, or conductivity. This is due, for one thing, to the thermal uncoupling of the green body by an insulation against the support, for example, by floatation on a gas membrane. For another, the simultaneous, planar illumination bears the advantage that temperature gradients (such as appearing, for example, in selective laser sintering, where there is no simultaneous illumination onto a surface but, instead, the surface is screened point for point) are omitted or at least reduced significantly, thereby improving the material properties and their homogeneity.

Moreover, compared to selective laser sintering, the process time is reduced radically, because the method according to the present invention renders it possible to sinter whole components in one go within seconds. Owing to the extreme reduction of the process time and the simplified handling, development can be significantly expedited. In particular, small batches such as, for example, in the production of sputter targets or PLD targets (English: “pulsed laser deposition (PLD)”), can be made more affordably and simply.

The use of light instead of a furnace may be associated with a reduction of the process time about a factor of 1000. Moreover, energy can be saved at a level of, for example, 20% to 99%. Energy saved can be translated into corresponding CO₂ savings. A further advantage is that electricity can be used which can be purchased on a sustainable basis. Gas/oil are not available CO₂ neutral on a large scale. Even thicker ceramics, for example, those having a thickness in a range between 0.1 mm and 20 mm, in particular, 0.5 mm and 10 mm, or >1 mm to 5 mm, can be produced within seconds with energy savings of at least 90%. In particular, energy savings can be attained while reducing delivery times at the same time.

The ceramic starting material may have, in particular, a thickness at least 0.001 mm, at least 0.01 mm, at least 0.1 mm, at least 0.5 mm, at least 1.0 mm or at least 2.0 mm. The thickness lies, for example, in a range between 0.1 and 12.0 mm, in particular, 0.2 and 10.0 mm, 0.5 and 8.0 mm, 1.0 and 5.0 mm, or 10 and 4.0 mm.

In a preferred embodiment the ceramic starting material is pre-heated to a medium temperature, for example 50% of the maximum temperature during the sintering process. This significantly reduces the temperature gap by which a particularly rapid heating is required. This allows a larger material thickness to be successfully processed and, in particular, homogeneous material properties to be generated. The step of pre-heating may also be carried out at lower heating rates over extended periods of time than the actual sintering step. Moreover, in this case, a significantly lower power density is required than for the sintering, and it is conceivable to utilize a convention furnace for the step of pre-heating or to combine the step with burning out sintering materials.

In a preferred embodiment the irradiation of heat from the ceramics is reduced by suitable mirrors. A mirror shaped for example elliptically or parabolically and coated e.g., with gold to reflect, in particular, the emitted infra-red radiation, can be used to reflect the emitted radiation back towards the ceramics. This allows power to be reduced which is required to maintain the temperature. This can improve efficiency when using long illumination periods.

In a preferred embodiment the illumination happens from at least two sides.

In a particularly preferred embodiment material thicknesses from 0.1 to 12.0 mm, in particular, from 0.2 to 10.0 mm, from 0.5 bis 8.0 mm, from 1.0 to 5.0 mm, or from 2.0 to 4.0 mm, for example about 4 mm are processed. Hereby, preferably, the illumination will be from two sides, and a pre-heating step will be used.

Moreover, the method allows for manufacturing complete components, for example, multilayer capacitors, in one sintering process.

Optionally, in a further aspect, the method according to the invention can be used to create dislocations, at least locally. In ceramics a high density of such dislocations can be of particular advantage for their performance. This is because dislocations can be used to improve and/or purposefully adjust functional and mechanical characteristics of ceramics. Among the properties of a ceramic product which may be influenced, in particular, improved, inter alia, by means of dislocations, are, inter alia, the following:
the resistance of the ceramics against cracking;
the deformability of the ceramics, in particular, the high temperature deformability;
the fracture toughness of the ceramics;
the wear behavior of the ceramics;
the catalytic activity of the ceramics;
the electro-optical characteristics of the ceramics;
the electric, ionic and/or thermal conductivity of the ceramics; and/or
ferro-electric and/or semiconducting characteristics of the ceramics.

Even secondary properties of ceramics, such as for example, the inclination towards interdiffusion upon co-sintering different phases in one multilayer composite (e.g., capacitors, piezoelectric actuator, solar cells, solid state batteries, fuel cells and electrolytic cells) or the homogeneity upon separating metallic lithium (lithium dendrite growth) in novel batteries, may also be influenced, in particular, improved by dislocations.

Thus, the method allows ceramics to be influenced, depending on their later desired application, in terms of the number and density of the dislocations introduced, and thereby in turn the characteristics of the ceramics, above all their functional and mechanical properties as mentioned above, for example, to be purposefully influenced, in particular, adjusted and/or improved.

Furthermore, dislocations may replace and/or supplement chemical doping. This can help to reduce the complexity of the materials, allowing for less complex raw material supply chains as well as a sustainable and more economic production. At the same time, this also provides a potential for easier recycling. Furthermore, using the proposed method a good mechanical deformability of the ceramics after sintering can be attained. This property can be used for a secondary shaping requiring plastic deformability, in particular, bending, folding, deep drawing, forging and/or extruding.

Thus, the proposed method may lead to a significant improvement of the properties of known ceramics. Hereby, the method can be realized with little technical expenditure. Additionally, because the method imposes only low requirements on basic technical parameters it is particularly easy to integrate into existing manufacturing processes. Since the method works contactless (i.e., above all, it requires no contacting of the sample body such as “flash sintering”), it can be implemented particularly easily. Therefore, even existing production processes can be simply and affordable retrofitted so as to utilize the proposed method. Hereby, the light source may be chosen from a large number of even conventional light source. This makes the implementation of the method particularly affordable. Also, the method may be utilized for a large number of different geometries of the sample body. In particular, processes with continuous material transport through the illuminated zone are possible. This makes the proposed method highly suitable for mass production.

By radiating light, preferably, a controlled and/or controllable temperature profile within the ceramics can be adjusted. For example, this may be a spatial temperature profile within the ceramics. This in turn allows for a particularly good and reliable control of dislocations with very high dislocation density to be achieved, and this in turn allows for a corresponding control over properties of the ceramics. Also, optionally, gradients may be generated in certain characteristics of the ceramics, which means that the values of the characteristics change gradually from location to location. Using a temporal power density profile of the irradiation it is also possible to create ceramic products with characteristics gradients. For example, it is possible to produce products with a high-density surface layer of, for example, larger than 90% or larger than 95%, in particular, without open or, respectively, percolating porosity, and an underlying volume with low density with percolating porosity and, therewith, gas permeability. Such products are of interest, for example, for use in fuels cells or water splitting. Due to the high density the surface layer is gas-tight while the volume lying underneath provides a good reaction chamber due to its porosity.

Using the proposed method, it is possible for the first time to create dislocations with sufficient number and density in a ceramic product to influence, in particular, improve the properties of the ceramics even for challenging use cases. The method optionally allows to create dislocations under controlled conditions and, therefore, is also reproducible.

In particular, the method works particularly well with short wavelengths. It has been known from other sources that additives provide for a better absorption with long wavelengths and for better results upon selective laser sintering. However, it is better to not have to rely on additives which are sometimes disadvantageous. Surprisingly, significantly more energy is absorbed when the method is carried out in a nitrogen atmosphere. Here, the oxygen defects act in a way similar to an absorbing additive. Preferably, the method is carried out in a nitrogen atmosphere. Preferably, the method is free of absorbing additives.

For example, visible light and/or UV light may be used. In the alternative or in addition, also light in the infrared spectral range may be utilized. By irradiating light, for example in the visible and/or UV range, the temperature profile within the ceramics can be controlled, in particular, adjusted with high precision. By choosing the appropriate wavelength, in particular, by choosing the spectral range (UV, VIS, IR), the degree of efficiency can be adjusted with particular reliability. Especially preferably, blue laser light as a continuous wave (non-pulsed, English: “continuous wave”) is utilized, in particular, laser light having a wavelength in a range between 200 nm and 700 nm, for example 300 nm and 600 nm or 400 nm and 500 nm.

A laser having a wavelength of, for example, 450 nm corresponds to a photon energy of 2.7 eV. If the photon energy is larger than the band gap then the material will absorb almost 100% of the light. Otherwise, it will be almost transparent (see glass). For most ceramics the band gap lies between 2 and 5 eV. For most relevant oxides between 2.7 and 3.8 eV. However, the band gap drops with temperature ab and is reduced about approximately 1 eV at 1200° C. Thus, for most oxides approximately 2 eV is sufficient to achieve a high degree of efficiency at the maximum process temperature.

Red lasers with 800 nm wavelength (1.5 eV) are disadvantageous. The light is not absorbed efficiently and, therefore, 10 to 20 times the power are required. CO₂ laser lasers with 10000 nm wavelength (0.15 eV) present even larger problems of effective absorption.

Thus, preferably, the photon energy will be at least 2 eV and lies, in particular, in a range between 2 eV and 5 eV, for example, between 2.5 eV and 4.0 eV, or between 2.7 eV and 3.8 eV. Preferably, more than one wavelength will be utilized simultaneously so as to avoid any precipitous modification of absorption efficiency, thereby, preferably, increasing the mechanical stability and homogeneity.

In principle, the incident light is absorbed by the ceramics or the green body respectively, in particular, at or near the surface upon which the light in incident, where the interior of the material can also be heated by transmission of heat from the surface. In a particularly suitable embodiment, thin green bodies are used, whereby purposeful deactivation of the light also allows very high cooling rates. This method can also be used to sinter multilayer composites and composite materials, in particular, solid-state batteries, actuators, capacitors and fuel cells.

Hereby, for example, a green body may refer to the ceramics prior to the sintering process, i.e., the ceramic starting material. Hereby, the term leaves open whether the starting material is, for example, a sheet or a compressed powder and what geometry it may have.

In one embodiment the ceramic starting material has a sheet-like geometry. For example, adaptive (laser) lenses may be utilized, and these can be used to precisely and quickly control the introduced light power. Thus, during the compaction occurring in the course of the sintering process, dislocations can be introduced into the ceramics at the same time. Owing to the so controllable quick heating and cooling rates, optionally, dislocations can be introduced into the ceramics to a high degree, which would not be possible conventionally, like, in a furnace, due to its thermal inertia. Then, by virtue of the dislocations, it is possible to improve multiple functional and mechanical characteristics of the ceramics. For example, in particular, in the case of small thicknesses of the ceramics, e.g., a thickness of less than 1 mm, the cooling rate may be controlled by switching off the irradiation, in particular, this allows even very high cooling rates to be achieved. This is a design parameter which is not available conventionally.

Thus, preferably a high cooling rate can be achieved by also switching off the light source and, therewith, by terminating the feed of heat energy. This allows for a rapid cooling-off period compared to conventional furnaces. Because, optionally, no conventional furnace is used there will be no thermal inertia of the furnace. This means that almost the entire thermal inertia is in the ceramics. Accordingly, the thermal inertia may be particularly small in the case of thin ceramics. As a result, rapid and precise temperature profiles can be operated.

It may be of advantage for the cooling-off to be actively controlled by light in that a step of externalization is provided, i.e., the direct holding at increased temperatures. In particular, an externalization step may be provided at a temperature in a range of, for example, 300° C. to 1000° C. and, for example, for a period of several seconds, for example, at least 10 s, up to a few minutes, for example, at least 3 min, or even several hours, for example, a maximum of 3 hours. An externalization step may be advantageous, in particular, in the case of functional ceramics so as to achieve equilibrating of the point defects and, thereby, a stabile progression of the temperature dependent electrical conductivity of the ceramic products. However, providing an externalization step may also be used to minimize possible thermal shock effects or, respectively, the cracking caused by these, of the ceramics. In the alternative or in addition, it may also be provided to actively regulate the cooling-off temperature and to reduce the cooling-off rate in a temperature range of, for example, 800° C. to 100° C. across a span of at least 100 K to, e.g., at least 5 Kelvin per minute, further preferably at least 10 Kelvin per minute and/or at most 1 Kelvin per second, further preferably at most 20 Kelvin per minute. The cooling-off rate in the temperature range of 800° C. to 100° C. preferably lies across a span of at least 100 K in a range from 5 to 60 K/min, further preferably from 10 to 20 K/min. The cooling-off rate in the temperature range of 800° C. to 100° C. across a span of at least 100 K is preferably at least 5 K/min, further preferably at least 10 K/min. The cooling-off rate in the temperature range of 800° C. to 100° C. across a span of at least 100 K is preferably at most 1 K/s, further preferably at most 20 K/min.

Hereby, the method is particularly suitable for sintering electrolyte layers and/or multilayer composites for fuel cells, electrolytic cells and solid-state batteries as well as ceramic sensors.

Thus, the proposed method allows dispensing, totally or at least in part, with the use of sintering furnaces used conventionally for heating the starting material. This bears a number of significant advantages: an enormous amount of energy can be saved because there is no longer the need to heat up and cool down again entire furnaces. Radiating light further allows for an extremely dynamic temperature progression in the ceramics. The inert heating and cooling-down characteristics of the furnace can be overcome. Thus, in contrast to heating tapes, furnaces or electricity, a highly efficient control over the temperature of the ceramics can be maintained.

In one embodiment, the ceramic material is sintered by means of a sintering furnace or in another manner prior to commencement of the light irradiation and/or after completion of the light irradiation. In this case, the proposed method may, for example, be brought in only when needed at a high dislocation density.

Preferably, the proposed method has the following advantageous featured and characteristics which may be utilized each of them alone, all together, and/or in any combination thereof:
Ceramics of almost any geometry, above all, cuboid geometries having thicknesses below 1 mm or even having thicknesses between 1 mm and 5 mm, can be sintered using the method.
The method operates contactless.
The method is scalable.
The method is capable of processing a lot of surface space at the same time.
The method constitutes the first industrially scalable manufacturing process for ceramics such as ceramic membranes which optionally derive their superior characteristics from the dislocations created.
The method achieves very short process times at little technological expenditure.
The method, in particular, the sintering process associated with it, can be integrated directly into existing industrial tape casting plants.
The method optionally allows for a very high number and a very high density of dislocations.
The method can be well scaled and is easy to implement even for mass production (for example, readily available light sources can be used).
Process management on a laboratory scale can be conducted particularly similar to process management on an industrial scale, as a result of which further developments can be realized particularly rapidly and quality inspections are simplified.
The method can even be retrofitted in existing plants because only little technical hardware is required.
The method can be conducted as a continuous process.
A significant amount of energy can be saved upon production because no furnaces are required which would need to be heated and cooled off again. Only the material itself is heated.
The method can be well reproduced and controlled as a result of which also undesired side effects can be avoided, such as changes in conductivity caused by point defects in the ceramic material, because the process parameters are well defined—in contrast to, e.g., the situation in flash sintering. This reduces the complexity of the method.
The method operates pressure-less.

Thus, the method can be particularly well utilized in the production of ceramics in one or more of the following areas: fuel cell technology, electrolytic cells, solid-state batteries, sensors, solid state batteries, hydrogen technology, solar cells, catalytic technology, capacitors and actuators.

It goes without saying that the person skilled in the art understands that during irradiation of the light there is a fluent transition from the ceramic starting material to the ceramic product as a result of the sintering process.

Hereby, preferably, the invention allows the temperature to be adjusted, in particular, to minimize a lateral variation of the temperature profile, such that no large local gradients are created in the ceramic starting material. This makes the sintered material more tear-resistant. In addition, optionally, the transitions between illuminated and not illuminated areas may be designed as a gradient.

In one embodiment, a surface of 1 cm² or more, preferably 250 cm² or more, and/or of 2000 cm² or less, preferably 100 cm² or less, of the material is illuminated simultaneously.

The ceramics produced by means of the method may be particularly capable due to their optional high dislocation density. For example, the method can be used to produce functional ceramics. When using functional ceramics there is a demand for ceramics to be as capable as possible because this benefits the total system (e.g., a battery).

Hereby, preferably functional ceramics is to be understood as ceramics having specific functional properties, e.g., in terms of capacitors, sensors or battery membranes. It is distinguished, for example, from the structural ceramics which defines its added value by its structure and mechanical properties. Hereby, dislocations have been defined in pertinent technical literature, e.g., “Theory of dislocations,” 3^{rd} edition, Peter M. Anderson, John P. Hirth and Jens Lothe, Cambridge University Press. Dislocations within the purview of the present application are, preferably, one-dimensional crystal defects in the material, which can preferably be generated upon production.

In the alternative or in addition hereto, it may also be provided that the heating of the ceramic starting material in some regions is carried out using a heating rate of (a) 1 K/s or more, preferably about 10 K/s or more, preferably 100 K/s or more, preferably 1000 K/s or more, (b) 10000 K/s or less, preferably 5000 K/s or less, preferably 1000 K/s or less, and/or (c) between 10 and 5000 K/s, preferably between 100 and 2000 K/s, preferably between 100 and 1500 K/s, preferably between 100 and 1000 K/s.

In that, by radiation of light, corresponding heating rate are achieved in the ceramic material it is possible to optionally realize a high number and a high density of dislocations in the ceramic product.

Optionally, the maximum heating rate is 2500 K/s, preferably at most 500 K/s, preferably at most 150 K/s, preferably at most 50 K/s, preferably at most 50 K/s. In the alternative or in addition, the heating rate may also be 1 K/s or more.

For example, in one embodiment the heating rate is between K/s and 5000 K/s, preferably between 50 K/s and 1000 K/s, preferably between 50 K/s and 800 K/s, preferably between 100 K/s and 600 K/s.

For example, in one embodiment the target temperature is reached using a heating rate of more than 500 K/s in less than 5 seconds, preferably in less than 1 second, further preferably in less than 0.1 seconds. For example, the target temperature is stabilized with an accuracy of +/−20 K within less than 10 seconds, preferably less than 5 seconds, further preferably less than 2 seconds, even further preferably less than 1 second.

In the alternative or in addition hereto, the cooling rate is between 25000 K/s and 50 K/s, preferably between 1000 K/s and 50 K/s. In particular, the cooling rate from the sintering temperature to a temperature of 1000° C. is preferably very quick. Preferably, the cooling rate from the sintering temperature to a temperature of 1000° C. lies in a range from 50 K/s to 1000 K/s, for example from 100 K/s to 500 K/s, or from 150 K/s to 250 K/s.

In particular, the cooling rate may also depend on the thickness. For example, the quotient of the cooling rate and the material thickness may lie in a range between 25000 K/(mm*s) and 10 K/(mm*s), preferably between 1000 K/(mm*s) and 50 K/(mm*s). Upon further irradiation of light at higher power densities for very short periods, even much higher heating rates may occur, for example, up to 5,000,000 K/s, up to 1,000,000 K/s, or up to 500,000 K/s. Using the light flash, for example, a thin layer may be produced on a porous underground.

In one embodiment, the heating rate on the illuminated surface can be determined. Then, the heating rate can be controlled by measuring the temperature change on the illuminated surface. This can happen, preferably, contactless using a suitable pyrometer. Other methods of measuring the temperature are also possible, for example, using thermal elements, resistive temperature sensors or indirect measuring methods based on characteristics of the material to be sintered. In a preferred embodiment, the power density during heating up is selected higher than what is subsequently required to maintain the temperature to keep the heating rate as high as possible and constant. Hereby, preferably, the power density during heating up is increased so as to attain a heating rate as even as possible.

In order to control the heating rate, for example, the power density of the incident light as a parameter may be controlled directly. Such controlling may optionally include the adjustment of a locally and/or temporally varying heating rate. Also, the parameter of power density can be well accessed metrologically.

Therefore, in one embodiment, the heating rate is controlled by means of the power density of the incident light. Optionally, the power density is between 2 W/cm² and 750 W/cm², preferably, between 4 W/cm² and 500 W/cm², even more preferably, between 5 W/cm² and 200 W/cm², or between 10 and 150 W/cm². The power density is less than 800 W/cm², for example at most 750 W/cm², at most 700 W/cm², at most 650 W/cm², at most 600 W/cm², at most 550 W/cm², at most 500 W/cm², at most 450 W/cm², at most 400 W/cm², at most 350 W/cm², at most 300 W/cm², at most 250 W/cm², at most 200 W/cm², at most 150 W/cm², at most 100 W/cm², or at most 75 W/cm². The power density may be, for example, at least 1 W/cm², at least 2 W/cm², at least 4 W/cm², at least 5 W/cm², at least 10 W/cm², at least 20 W/cm², at least 30 W/cm², at least 40 W/cm², at least 50 W/cm², or at least 60 W/cm².

For shorter periods, even much higher power densities may be radiated, as described above (light flash).

A mathematical examination shows that the maximum temperature of the ceramics, in particular, of the green body, may approximately depend on the fourth root of the power density as soon as a sample temperature has become adapted according to the power density of the incident light. For example, 5 W/cm² corresponds to approximately 750° C., and 200 W/cm² corresponds to approximately 1750° C. for an exemplary ceramic sample body, in particular, green body. When the power density lies above the power density required for the current temperature the ceramics will heat up. When the power density is reduced the ceramics will cool down. At high temperatures a large portion of the power density is used to compensate the heat energy dissipating from the ceramics.

Hereby, the power density is controlled, in particular, with a good temporal resolution, and this allows for highly precisely defined power density profiles or temperature profiles respectively. For example, the ceramics may be heated up using a very high power density which will then quickly adapted to a lower value that corresponds to the current temperature. This allows the ceramics to be heated very quickly with the maximum temperature being reached quickly and, in particular, with high precision. This allows, for example, for a significant reduction in particular, minimization of the time in which the temperature is increased from 90% to 100% of the target temperature, compared to conventional methods, such as a conventional furnace, and, at the same time, an exceeding of the target temperature can be prevented. Thus, the technical controlling of the power density allows for almost any temperature profiles to be realized, in particular, including rapid temperature changes. Furthermore, the local (and/or temporal) variation of the temperature profile allows for locally varying properties and dislocation densities to be adjusted in the ceramic material. Thus, the user is provided with significantly more flexible options of configuring the temperature profile. Preferably, this allows even more complex temperature profiles.

Preferably, the power density can be switched on and off or density-controlled in any way with particular low temporal latency. Hereby, the achievable switching times are defined by the light sources and the optics used and may be, e.g., 1 second or less, preferably, 1 millisecond or less. Hereby, “switching time” preferably refers to the time period required to switch the illumination on and off again. In the alternative or in addition, the switching may also be regulated by the optics, while the light source, for example, shines continuously.

Optionally, the change of the power density is between 1%/s and 100000%/s, preferably, between 100%/s and 10000%/s. In particular, the changing rates can be achieved in the range between 50% and 100%, preferably, 75% and 100%, even more preferably, 90% and 100%, of the sintering temperature.

Optionally, the power density can be reduced by more than 80% and, preferably, switched off completely, in less than 10 s, preferably, in less than 1 s, preferably, von less than 10 ms.

In the alternative or in addition, it may also be provided that, in particular, the heating-up in some regions of the ceramic starting material happens by means of irradiation of light for a period of time of (a) at least 0.25 seconds, preferably, of at least 3 seconds, preferably, of at least 20 seconds, and/or (b) at a maximum of 10 minutes, preferably, at a maximum of 8 minutes, preferably, at a maximum of 5 minutes, preferably, at a maximum of 3 minutes, preferably, at a maximum of 1 minute, preferably, at a maximum of 30 seconds, preferably, at a maximum of 10 seconds, preferably, at a maximum of 5 seconds, preferably, at a maximum of 3 seconds, preferably, at a maximum of 1 second.

Due to the short period of time, the method is also particularly suited for large-scale production.

Optionally, the period of time is 10 minutes at most, preferably, at most 1 minute, preferably, maximal 10 seconds.

For example, in one embodiment the period of time is between 0.1 second and 10 minutes, preferably, between 1 second and 1 minute, preferably, between 2 seconds and 30 seconds.

In the alternative or in addition, it may also be provided for the locally created dislocations to have a density of 10⁵/cm² or more, preferably, of 10⁶/cm² or more, preferably, 10⁷/cm² or more, preferably, 10⁸/cm² or more, preferably, 10⁹/cm² or more, preferably, 10¹⁰/cm² or more, preferably, 10¹¹/cm².

Not only is the method particularly easy to implement, but it also allows for correspondingly high dislocation densities.

For example, the dislocation densities specified above are those which are created locally. In other words: For example, the dislocation densities specified are dislocation densities for which the dislocations created at least locally are sufficient.

This may mean that by irradiating light and heating up the material dislocations are created on a larger scale than the dislocations created at least locally, where the dislocations created on the larger scale do not always meet the specified dislocation densities and, therefore, are not counted as the locally generated dislocations. For example, around the locally generated dislocations (having corresponding dislocation densities) further dislocations may exist which, however, exhibit a lower density. For example, the dislocation densities relate to a surface of 1 μm², 1 cm² or 1 m² of the ceramics. In the case of larger surfaces, the density may be tested in local samples, for example, at ten representative locations.

In the alternative or in addition, it may also be provided that
(i) the locally generated dislocations are located within the area of the ceramic material heated by the light;
(ii) the power density of the radiated light (a) lies between 1 W/cm² and 750 W W/cm², further preferably, between 5 W/cm² and 150 W/cm², and/or reaches (b) a defined or definable state with an accuracy of better than 10%, better than 5%, better than 2% or better than 1% in less than 5 seconds, preferably, in less than 2 seconds, further preferably, in less than 1 second, further preferably in less than 0.5 seconds, further preferably in less than 0.1 second, and is subsequently stabilized; and/or
(iii) the power density and/or the temperature profile can be freely configurated.

Therefore, it is not necessary for the entire area of the ceramic heated by the light muss to have materials dislocations. And/or it will also have regions with dislocations that do not meet the requirements of the ones locally generated. Dislocations are provided merely optionally. The invention relates, in particular, also to ceramic products without dislocations.

In the alternative or in addition, it may also be provided that the ceramic starting material includes at least one ceramic multilayer composite, at least one ceramic composite material and/or at least one ceramic powder, and/or is provided in the form of a sheet, and endless tape, a, preferably, cuboid or round, pellet and/or as a solid body.

The ceramic starting material can be handled particularly well and securely in that it is provided as a pellet or a solid body.

A pellet may include or consist of, for example, a ceramic powder material compressed into a ceramic body.

A green body within the purview of the present invention may be a blank made of ceramic powder prior to sintering which is made, for example, using a compressing process. A green body within the purview of the present invention may also be a blank prior to sintering which is made by means of liquid-bases processes such as slip casting. A green body within the purview of the present invention may also be a blank prior to sintering which is made by means of cast sheets.

In one embodiment the ceramic starting material is provided in the form of an endless tape and/or moved in relation to the light source. This allows even large surfaces to be processed, in particular, sintered quickly and economically.

In the alternative or in addition, it may also be provided that
(i) the thickness of the ceramic starting material is between 0.00005 mm and 15.0 mm, preferably, between 0.001 mm and 10.0 mm, preferably, 0.1 mm and 5 mm, preferably, between 0.5 mm and 4.0 mm,
(ii) the ceramic starting material includes or consists of SrTiO₃, and/or TiO₂ as material, and/or where the ceramic product comprises or constitutes a ceramic membrane or;
   and/or
(iii) the ceramic starting material includes one or more of the following materials:
   (a) any ceramic material, in particular, a non-metallic inorganic material with a crystalline structure;
   (b) a ceramics with a perovskite structure, spinel structure, sphalerite structure, wurtzite structure, sodium chloride structure, or fluoride structure;
   (c) a ceramics on the basis of barium titanate, barium zirconate, lead zirconate titanate, titanium oxide, silicon carbide, silicon nitride, boron carbide, boron nitride, zirconium diboride, nickel oxide, zinc oxide, zirconium oxide, strontium titanate, magnesium oxide, lithium lanthanum titanate, lithium lanthanum zirconate, lithium lanthanum tantalate, lithium cobalt oxide, lithium manganese oxide, lithium nickel manganese oxide and/or alumina, each with any doping additives and/or sintering additives as well as mixtures of various of these materials;
   (d) any metal; or/and
   (e) one or more materials from the group comprising: silver, lithium, palladium, platinum, gold, nickel, titanium, aluminum, copper, iron, niobium, chrome, vanadium, iridium, tantalum, osmium, rhenium, molybdenum, wolfram, magnesium or an alloy from various of these metals;
   (f) any non-metallic inorganic material, which predominantly has no crystalline structure and welches which is given its shape by means of a sintering process.
   (g) silicate fibers, borosilicate glass, and Tetrabor silicide.

The method according to the invention allows sintering processes to be carried out at high temperatures with non-metallic inorganic materials. This is also possible when there is predominantly no crystalline structure present. For example, it can be used to sinter ceramic or glass fibers to form a solid and highly porose block. One example is the compound made of highly porose embedded glass fiber with a dense surface layer which are utilized as heat-resistant tiles for re-entry of space vessels into the atmosphere. The components are known, for example, from the Space Shuttle and are also utilized in novel and future space vessels such as, e.g., the SpaceX Starship. Using the illumination as heat transfer medium the starting material can be produced with particularly speed and energy efficiency. Moreover, the surface layer and the solid body can be heated to different levels. In addition, the manufacturing temperature is not limited by a furnace and, therefore, can be chosen to be higher. This can improve the selection of materials allowing for higher operation temperatures.

Ceramics with preferred thicknesses are relevant for usual applications. Ceramics with preferred thicknesses can be sintered using simple and readily available light sources, thereby achieving a high dislocation density. This is because, the heating of the ceramic materials by the light utilized can then by controlled particularly well. Therefore, it is preferred that the method be utilized for producing thin ceramics.

The person skilled in the art is aware of the fact that the thickness of the finished ceramic product can differ from that of the ceramic starting material. For example, a reduction in thickness by about, for example, 40% will occur during sintering.

In one embodiment, the thickness of the ceramic starting material is, preferably, 20 mm or less, 5 mm or less, preferably, 2 mm or less, preferably, 1.0 mm or less, preferably, 0.1 mm or less, preferably, 0.02 mm or less, preferably, 0.01 mm or less, preferably, 0.005 mm or less. Optionally, the thickness is 0.0002 mm or more, preferably 0.002 mm or more, preferably, 0.01 mm or more, preferably, 0.05 mm or more, preferably, 0.1 mm or more, for example, 0.2 mm or more, 0.5 mm or more, or 1.0 mm or more. For example, the ceramic product may have a thickness of between 0.001 mm and 5 mm, in particular, between 0.01 mm and 2 mm.

In one embodiment the ceramic product may include a membrane, in particular, a thin membrane. This membrane, in particular, thin membrane, may preferably exhibit the afore-mentioned thicknesses.

In the alternative or in addition it may also be provided that the light is to illuminate at least one surface, in particular, side, preferably, main side, of the ceramic starting material, preferably, completely or partially.

By virtue of the complete illumination the ceramic material may even be fully heated up in a single operation and so fully processed, in particular, sintered and/or provided with dislocations.

Main side is preferably to understood as the largest-in-surface side of the ceramic starting material, such as, in particular, a pellet or solid body.

In the alternative or in addition it may also be provided that
(i) the light is irradiated parallel and/or sequentially, in particular, while relatively displacing, preferably, continuously, the ceramic material in relation to the incident light, onto a plurality of areas, in particular, surfaces areas, of the ceramic starting material, so as to create dislocations in the ceramic product in a manner parallel or sequentially at a plurality of local spots;
(ii) by means of the irradiation a defined geometry, in particular, with a large surface, is generated in a heated zone, which is square or the shape of which can be freely selected by the user;
(iii) the irradiation can be reduced by more than 90% with a delay of less than 10 seconds, preferably, in less than 1 second, further preferably, in less than 0.1 second, preferably, less than 0.01 second, further preferably, less than 1 millisecond, even further preferably, less than 0.1 millisecond, and/or where switching off the irradiation achieves a cooling-off rate of more than 10 K/s, further preferably, more than 50 K/s, even further preferably, more than 200K/S; and/or
(iv) the temperature profile can be controlled to be locally or/and temporally varying.

When the irradiation happens in parallel, for example, a plurality of light sources may be utilized. This allows even large surface areas to be quickly processed, in particular, heated up, and/or high heating rates to be attained even across a large surface area and/or the volume regions lying underneath it.

In the alternative or in addition it may also be provided that the irradiation happens in such a way that the temperature profile created in the ceramic material varies locally so as to attain temperature gradients and/or patterns of dislocation densities. To that end, for example, a local dislocation density variation may be carried out.

In the alternative or in addition it may also be provided that the light
(i) includes wavelengths in the visible wavelength range or in the non-visible wavelength range, in particular, in the UV range or in the visible range, preferably, consisting only of those,
(ii) is emitted from at least one light source including, in particular, at least one light emitting diode, at least one Xe flash light, at least one laser, at least one UV light, at least one medium pressure UV emitter and/or at least one metal halide lamp, at least one halogen lamp, at least one infrared emitter,
(iii) is guided by an optics onto the ceramic starting material and/or, preferably, focused onto the area to be heated, and/or
(iv) warms up the ceramic starting material on the surface and/or within a volume area adjacent to the surface.

When the light is irradiated from a plurality of light sources each light source may, preferably, be an individual type of light source. In that the light is irradiated from outside and impacts a surface of the ceramic starting material, then a volume area adjacent to the surface will also heat up very reliably.

Hereby, the light may be irradiated, in particular, in the case of a flat ceramics, from above, from below and from both sides. In the alternative, the light may be irradiated only from one side. Hereby, the side from the no light is irradiated may be open or covered or provided with a mirror. Embodiments are possible in horizontal or vertical orientation, as well as any angles.

A light source preferably comprises: one or more light emitting diodes, one or more laser(s) (in particular, with a wavelength in a range from 200 nm to 700 nm, for example, 300 nm to 600 nm or 400 nm to 500 nm), one or more Xe flash lights (in particular, in quasi-continuous multi-pulse operation), one or one or more UV lamp(s), in particular, one or more medium pressure UV emitter(s) and/or one or more metal halide lamp(s) or one or more halogen lamp(s) or infrared emitter(s).

The invention can be realized using a laser as light source. For example, a laser may also be utilized additionally to and/or simultaneously with another light source to be able to produce patters with nuances.

However, it is an advantage of a laser hat it is capable of strongly bundling light, a property for which laser light sources are typically optimized. However, this reduces the surface which can be processed at the same time. Therefore, for utilization in this invention, the laser beams should preferably first be widened. Hereby, preferably, a diode laser is used, preferably consisting of a plurality of diodes, in particular, stacks of diodes, with a homogenous distribution of intensity.

This is because the present invention allows large surface areas to be irradiated simultaneously and almost homogenously. This allows large surfaces to be processed quickly and cost-effectively. In particular, this allows processing of an endless band quickly and affordably.

The task is solved by the invention according to a second aspect thereof by proposing a:

Device, in particular, (i) for producing ceramics (with or without dislocations), (ii) for executing the method according to the first aspect of the invention and/or (iii) being configured to carry out the method according to the first aspect of the invention, the device comprising at least one receiving means for receiving a ceramic starting material and at least one light source for radiating light onto the ceramic starting material that is or can be received in the receiving means, wherein preferably the device is configured to radiate the light onto the ceramic starting material in order to heat this at least in some regions and, as a result, to produce a ceramic product, and wherein the receiving means has an insulation.

The insulation should be sufficiently sturdy to withstand even illumination for the required process time.

The heat conductivity of the insulation at 1400° C. may be, for example, less than 400 W/(m*K), at most 50 W/(m*K), at most 20 W/(m*K), at most 10 W/(m*K), at most 5 W/(m*K), at most 2 W/(m*K), at most 1 W/(m*K), at most 0.5 W/(m*K), or at most 0.25 W/(m*K). The heat conductivity of the insulation may be, for example, at least 0.01 W/(m*K), at least 0.05 W/(m*K), at least 0.1 W/(m*K), or at least 0.2 W/(m*K).

The density of the insulation may lie, for example, in a range between 0.05 and 0.25 g/cm³, in particular, in a range between 0.10 and 0.15 g/cm³, for example, at about 0.12 g/cm³.

At a temperature of 1400° C. the insulation will preferably permit at most 50 W/cm², at most 15 W/cm², or at most 5 W/cm² of thermal flow from the ceramic starting material and/or the ceramic product.

In an embodiment in weightlessness, no support and, therewith, no insulation is required.

As insulation, for example ceramic wool or exfoliated graphite (English “expandable graphite”) may be utilized. exfoliated graphite is particularly preferred because this is less reactive the ceramics than ceramic wool.

An advantageous insulation may also include or consist of a precious metal. Preferred are, in particular, high-melting-point precious metals. The insulation may, for example, include or consist of a material which is selected from the group consisting of iridium, platinum, rhodium, ruthenium, osmium, rhenium, wolfram, tantalum, molybdenum, hafnium and alloys composed of two or more of these. Iridium and platinum as well as alloys of these are particularly preferred. Even more preferred is iridium. The insulation may, in particular, be present in the form of a wool, a web and/or a sheet.

The insulation preferably comprises a material which is selected from the group consisting of one or more precious metals, exfoliated graphite, ceramic wool, in particular, alumina, and combinations of two or more of these.

The insulation preferably has a thickness in a range between 0.25 and 5.0 cm, between 0.5 and 3.0 cm, between 0.75 and 2.5 cm, or between 1.0 and 2.0 cm. The thickness of the insulation may, for example, be at least 0.25 cm, at least 0.5 cm, at least 0.75 cm, or at least 1.0 cm. The thickness of the insulation may, for example, be at most 5.0 cm, at most 3.0 cm, at most 2.5 cm, or at most 2.0 cm.

The insulation may also be realized in the form of a gas film. In particular, the insulation may include or consist of a gas film. For example, gas may flow through holes in a metal plate thereby creating a gas film upon which the ceramics will then float.

The insulation provides for a particularly homogeneous temperature distribution which in turn is associated with particularly homogeneous material properties. Moreover, the insulation allows the method to be carried out at relatively low power densities because undesired loss of energy can be avoided or at least drastically reduced. The fact that it is, of all things, exfoliated graphite that is particularly suited, is surprising. For a conventional sintering in a furnace exfoliated graphite is not suitable because it would burn completely. However, exfoliated graphite can perfectly withstand the short sintering times and relatively low power densities of the present invention. A gas film upon the ceramics floats may also serve as isolating support. The amount of heat dissipated through the support is a dynamic variable when the temperature changes. In a case where a target temperature is to be maintained for many seconds a copper support having a thickness of 1 cm and having a heat conductivity of 400 W/mK could dissipate approximately 6000 W/cm². In contrast hereto, a ceramic wool having a heat conductivity of 0.4 W/mK would be able to dissipate merely 6.4 W/cm². It becomes apparent that the thermal flow through the insulation constitutes only a fraction of the power density of the illumination while a metal support permits many times as much undesired thermal flow.

In order to further improve energy efficiency, in particular, in the case of longer illumination periods, the emitted heat radiation of the ceramics during sintering may be reflected back towards the ceramics by means of a mirror system. For this purpose, for example, a parable or elliptically shaped and/or gold-plated mirror can be used. The device according to the invention allows for producing ceramics with high dislocation density. In particular, it allows for producing ceramics with dislocations by using it to execute the method according to the first aspect of the invention.

Therefore, the same advantages and the same utilization cases as described above in connection with the first aspect of the invention equally apply to the device.

In one embodiment the device may include a plurality of light sources. When the device includes a plurality of light sources each light source may, preferably, be an individual type of light source.

For example, using a plurality of light sources, it is possible to carry out the illumination of a ceramic starting material, provided, for example, in the form of a pellet and received or receivable in the receiving means, as described in connection with the first aspect of the invention. In the alternative or in addition, the device may also include an optics. This can be used to adjust the illumination of the material. The optics may comprise lenses, mirrors and/or the like.

In the alternative or in addition, the device may also include controlling means allowing for determining the heating rate of the heating-up, the time period of irradiating and/or the illuminated area and to correspondingly control, in particular, regulate and/or operate the irradiating of the light, in particular, in terms of the heating rate, the time period and/or the illuminated area.

In a particularly preferred embodiment, the method is realized by means of a particularly flexible device. The small size, roughly the size of a shoe box, and the option of operating the device by means of a common wall socket outlet (in Germany, 230V, 16 A) allow for an affordable utilization, e.g., on the table, in dental laboratories, small artisan shops or in glove boxes used in laboratories for materials sensitive to air.

Inside a housing which protects the environment from the light used a stack of light emitting diodes is mounted as a centrale component. These illuminate the ceramic product which is positioned on an exchangeable insulation. This can easily be removed which is enabled, for example, by a drawer which can be pulled out.

The light emitting diodes emit preferably UV light, preferably with a wavelength of 375 nm or 450 nm. Hereby, the light emitting diodes are connected to a water-cooled thermal sink, whereby the emitted light can be bundled using micro lenses and lenses so as to improve the power density. Preferably, these are arranged above the ceramics and may, in the alternative or in addition, by mounted at other angles.

Hereby, the temperature is read out by a suitable pyrometer, whereby, preferably, an active control loop exists between pyrometer data and power density.

The electricity supply, regulation and cooling of the light emitting diodes may be located in the same housing or, in the alternative, installed in a separate box, whereby a connection via cables and hoses is provided.

The peak load of the electricity supply can be significantly reduced by means of a suitable intermediate energy storage means. For a power density of 50 W/cm² on a surface of 80 cm² an output of at least 4 KW is required. This exceeds the maximum output of a common wall socket. An intermediate energy storage means may provide, for example, 8 KW for 30 seconds and then be recharged over a few minutes at significantly lower power. Here, for example, a common car starter battery may be utilized which allows for several illuminations before it requires recharging.

The machining area is preferably designed such that the support can be exchanged for other devices. For example, it is possible to utilize a support with insulation in a gas-tight chamber. This can allow the light to radiate at the top side through a quartz glass window while purposefully controlling the atmosphere, for example, by means of a continuous gas flow using a gas such as, e.g., air, oxygen, argon, nitrogen or forming gas. A quartz glass window also protects the device from pollution.

The task is solved by the invention according to a third aspect in that a ceramic product (with or without dislocations), in particular, produced and/or producible by means of the method according to the first aspect of the invention and/or by means of the device according to the second aspect of the invention, having, in particular, an at least partially sintered microstructure, is proposed.

The ceramic product may include, in particular, a sintered microstructure. The ceramic product may, for example, include a partially sintered microstructure or a completely sintered microstructure.

For example, the ceramic product may include, at least locally, dislocations with a density of 10⁵/cm² or more, preferably, of 10⁶/cm² or more, preferably, 10⁷/cm² or more, preferably, 10⁸/cm² or more, preferably, 10⁹/cm² or more, preferably, 10¹⁰/cm² or more, preferably, 10¹¹/cm².

The method according to the invention is the first to even allow production of a ceramic product which exhibits such a high dislocation density. Preferably, the local dislocation density is 10⁹/cm² or more, in particular, 10¹⁰/cm² or more.

A ceramic product according to the invention may include nano pores. This is true, in particular, when the ceramic product includes TiO₂, BaTiO₃, YSZ (English: “yttria stabilized zirconia”) or Li_{0.3}La_{0.7}TiO₃ as material.

Preferably, the ceramic product exhibits a porosity such that in a transmission-electron-microscopic (TEM) receiving means on a surface of 100 μm² at least 2 nano pores, further preferably, at least 4 nano pores, further preferably, at least 8 nano pores, further preferably, at least 10 nano pores, further preferably, at least 12 nano pores, further preferably, at least 15 nano pores, further preferably, at least 20 nano pores are present, in particular, when the sample thickness is 250 nm. The number of nano pores may, for example, be at most 150 nano pores, at most 100 nano pores, at most 75 nano pores, at most 50 nano pores, at most 40 nano pores, or at most 30 nano pores on a surface of 100 μm², in particular, in the case of a sample thickness of 250 nm. The number of nano pores lies preferably in a range between 2 and 150 nano pores, between 4 and 150 nano pores, between 8 and 100 nano pores, between 10 and 75 nano pores, between 12 and 50 nano pores, between 15 and 40 nano pores, or between 20 and 30 nano pores on a surface of 100 μm², in particular, in the case of a sample thickness of 250 nm.

In TEM images, two types of nano pores can be distinguished. There are pores that extend through the entire sample thickness. These pores appear in white. Other pores do not extend through the entire sample thickness and, therefore, appear less white up to even light grey. For the evaluation of the number of nano pores according to the invention, both types of nano pores are counted.

The number of observed nano pores depends on the sample thickness. In particular, the number of visible nano pores increases with sample thickness. However, even in the case of a quasi-zero sample thickness the number or pores itself will not be zero. Even a negligibly thin layer minimal will still exhibit a minimum of pores. Independent of the sample thickness, the number of nano pores on a surface of 100 μm² is, preferably, at least 2 nano pores, further preferably, at least 4 nano pores, further preferably, at least 8 nano pores, further preferably, at least 10 nano pores, further preferably, at least 12 nano pores, further preferably, at least 15 nano pores, further preferably, at least 20 nano pores. The number of nano pores per 250 nm sample thickness, independent of the sample thickness, may be, for example at most 150 nano pores, at most 100 nano pores, at most 75 nano pores, at most 50 nano pores, at most 40 nano pores, or at most 30 nano pores on a surface of 100 μm².

The observed number of pores that extend through the entire sample thickness decreases with increasing sample thickness. When this number is zero and, at the same time, many pores not extending through the entire sample thickness can be observed, it has to be assumed that the sample thickness is larger than the average pore diameter. It can be conversely concluded that, when approximately half of the pores extend across the entire sample thickness, the sample thickness corresponds approximately to the average pore diameter. Furthermore, the number of observed pores not extending across the entire sample thickness increases continuously with the sample thickness. It can be conversely concluded that, when predominantly or exclusively pores extending across the entire sample thickness are observed, the sample thickness is significantly smaller than the average pore diameter. According to the invention, the number of nano pores is indicated in relation to a sample thickness of 250 nm. This indication of the sample thickness does not mean that the ceramic product actually exhibits this thickness. Rather, the term “sample thickness” relates to the thickness of the sample examined. The sample thickness may be significantly smaller than the thickness of the ceramic products. The sample may be obtained, in particular, from the ceramic product in that a slat is cut out by means of a focused ion beam or by mechanical polishing with subsequent thinning by means of argon ions.

For a quantification of the number of nano pores the number of nano pores is determined in five image sections each having a size of at least 50 μm². The number of nano pores of the sample per 100 μm² is determined as the average value from the corresponding values of the five image sections. For determining the number of nano pores pro per 100 μm² in one image section it is not required for the image section to have a size of 100 μm². The image section may also have a size of more than 100 μm² or a size of less than 100 μm². The number of nano pores per 100 μm² can then be simply extrapolated by calculating. If, for example, in an image section with a size of 50 μm², a number of 8 nano pores is determined, then the result for this image section is 16 nano pores per 100 μm². If, for example, in an image section with a size of 200 μm², a number of 12 nano pores is determined, then the result for this image section is 6 nano pores per 100 μm².

Nano pores may exist parallel side by side with larger pores. However, porosity with larger pores is not desired and is preferably minimized. Nano pores, however, bear surprising advantages.

Nano pores may be associated with various advantages, for example, with an improvement of electric conductivity, in particular, in the case of TiO₂, and/or with an improvement of ion conductivity, in particular, in the case of YSZ. The ion or electric conductivity may increase, for example, by 10% or more compared to ceramics of identical composition but nano porosity.

In ferroelectric products, for example BaTiO₃, a change of the classic hysteresis curves for the polarization and the expansion can be observed. By applying an external electric field, the charge concentrations will align in the ferroelectric products. Areas of equal alignment will be created, so-called domains, which lead to a spontaneous polarization and expansion of the ceramic product, which can then be technically utilized. The spontaneous polarization is measured using a measuring circuit according to Sawyer and Tower, the expansion simultaneously measured by means of an optical position sensor.

Further increasing the electric field results in reaching a saturation polarization. Upon reducing the field strength to remanent polarization, at zero field strength, this will decrease ab and is reversible with an inversely applied field so that a hysteresis loop is created which is decisive in determining the characteristics of the ferroelectric product. The ceramic product according to the invention preferably exhibits a higher saturation polarization compared to a conventionally sintered sample of the same powder. The saturation polarization of a ceramic product according to the invention exceeds the saturation polarization of a conventionally sintered ceramic product of equal composition, preferably, by at least 10%, further preferably, at least 20%, further preferably, at least 30%, further preferably, at least 40%. The saturation polarization of a ceramic product according to the invention may exceed the saturation polarization of a conventionally sintered ceramic product of equal composition, for example, by at most 100%, at most 80%, at most 70% or at most 60%. The saturation polarization of a ceramic product according to the invention may exceed the saturation polarization of a conventionally sintered ceramic product of equal composition, for example, by between 10% and 100%, by between 20% and 80%, by between 30% and 70% or by between 40% and 60%.

In connection with the present invention, the term “conventional sintering” for the ceramics BaTiO₃ is to be understood as sintering in oxygen at 1220° C. for 5 hours at a heating and cooling rate of 10 Kelvin per minute. According to the invention, “conventional sintering” is to be understood generally as sintering up to a density of more than 90% in a conventional furnace at heating and cooling rates within a range of 1 to 200 Kelvin per minute. A comparison is suitable, preferably, when the grain sizes of the compared ceramics do not differ by more than a factor of two. The ceramic product according to the invention comprises, in particular, a saturation polarization of more than 12 μC/cm². Further preferably, the saturation polarization of the ceramic product according to the invention is at least 14 μC/cm², further preferably, at least 15 μC/cm², further preferably, at least 16 μC/cm², further preferably, at least 17 μC/cm², further preferably, at least 17.5 μC/cm². The saturation polarization may be, for example, at most 50 μC/cm², at most 40 μC/cm², at most 30 μC/cm², at most μC/cm², at most 20 μC/cm², or at most 18.5 μC/cm². The saturation polarization preferably lies in a range from >12 to 50 μC/cm², from 14 to 40 μC/cm², 15 to 30 μC/cm², 16 to 25 μC/cm², 17 to 20 μC/cm² or from 17.5 to 18.5 μC/cm². The values specified in this paragraph for the saturation polarization relate to, in particular, the case where the ceramic product comprises or consists of BaTiO₃.

When comparing the expansion, what is striking is that the ceramic product according to the invention exhibits a significantly narrower hysteresis curve than the comparison sample. Owing to the significantly smaller coercive field strength (the minimum in the expansion) it is easier to switch than the reference sample making it more suitable for, for example, actuator applications.

The coercive field strength of a ceramic product according to the invention is preferably at most 50%, further preferably, at most 40%, further preferably, at most 30%, further preferably, at most 25% of the coercive field strength of a conventionally sintered ceramic product of equal composition. The coercive field strength ceramic product according to the invention may be, for example, at least 2%, at least 5%, at least 10% or at least 15% of the coercive field strength of a conventionally sintered ceramic product of equal composition. The coercive field strength ceramic product according to the invention may be, for example 2% to 50%, 5% to 40%, 10% to 30% or 15% to 25% of the coercive field strength of a conventionally sintered ceramic product of equal composition.

In the ceramic product according to the invention, the coercive field strength lies, preferably, in a range from 0.005 to <0.19 kV/mm, 0.01 to 0.15 kV/mm, 0.02 to 0.10 kV/mm, or from 0.03 to 0.05 kV/mm. The coercive field strength is preferably less than 0.19 kV/mm, further preferably, at most 0.15 kV/mm, further preferably, at most 0.10 kV/mm, further preferably, at most 0.05 kV/mm. The coercive field strength may be, for example, at least 0.005 kV/mm, at least 0.01 kV/mm, at least 0.02 kV/mm, or at least 0.03 kV/mm. The values specified in this paragraph for the coercive field strength relate to, in particular, the case where the ceramic product comprises or consists of BaTiO₃.

By means of the present method defects can be introduced which have significant influence on the resulting domain structure. This becomes apparent in the change of the domain structure in FIGS. 17 and 18. While the domain wall density prior to an externalization step at, for example, 800° C., was small, this is visibly higher afterwards. A change has a multiplicate influence on the properties of the ferroelectric product. By means of precipitation at 800° C., and the refining of the domain structure associated there with, the expansion of the ceramic products can be increased. This becomes apparent by comparing the precipitated sample with the original one in FIG. 19. The progressions of the expansion shown there were measured as described in Example 9. The only exception is the frequency which, in this case, is 20 Hz.

The expansion of a ceramic product according to the invention exceeds the expansion of a conventionally sintered ceramic product of equal composition, preferably, by at least 15%, further preferably, at least 25%, further preferably, at least 50%, further preferably, by at least 70%. The expansion of a ceramic product according to the invention may exceed the expansion of a conventionally sintered ceramic product of equal composition, for example, by at most 150%, at most 125%, at most 100% or by at most 90%. The saturation polarization of a ceramic product according to the invention may exceed the saturation polarization of a conventionally sintered ceramic product of equal composition, for example, by 15% to 150%, 25% to 125%, 50% to 100% or by 70% to 90%.

The expansion of the ceramic product lies preferably in a range from >0.07% to 0.20%, 0.075% to 0.175%, 0.10% to 0.15%, 0.11% to 0.14%, or from 0.12% to 0.13%. The expansion of the ceramic product is preferably more than 0.07%, further preferably, at least 0.075%, further preferably, at least 0.10%, further preferably, at least 0.11%, further preferably, at least 0.12%. The expansion of the ceramic product may be, for example, at most 0.20%, at most 0.175%, at most 0.15%, at most 0.14%, or at most 0.13%.

In particular, in the case of BaTiO₃, two types of domains may occur, the 90° and the 180° domains. The ceramic products according to the invention preferably exhibit a high domain wall density. This allows for the adjustment of many ferro and dielectric properties. The high domain wall density may, for example, contribute to increasing the expansion.

Thus, the same advantages and the same application cases apply to the ceramic product as have been described above in relation to the first aspect of the invention.

For example, the ceramic product may be present in the form of a membrane, in particular, a thin membrane. As thin membranes functional ceramics are utilized, for example, in fuel cells, electrolytic cells, sensors, solid state batteries, gas separation membranes, actuators and capacitors. In particular, such thin membranes may be stacked in multiple layers any also contain layers such as metal electrolytes.

The product according to the invention can preferably be utilized in fuel cells, electrolytic cells, sensors and/or solid-state batteries.

In the alternative or in addition it may also be provided that
(i) the thickness of the ceramic product is between 0.00005 mm and 20 mm, where the ceramic product comprises or constitutes a ceramic membrane and/or where the ceramic product comprises or consists of SrTiO₃, and/or TiO₂ as material;
and/or
(ii) the ceramic product comprises one or more of the following materials:
   (a) any ceramic material, in particular, a non-metal inorganic material with a crystalline structure;
   (b) a ceramic with a perovskite structure, spinel structure, sphalerite structure, wurtzite structure, sodium chloride structure, or fluoride structure;
   (c) a ceramic on the basis of barium titanate, barium zirconate, lead zirconate titanate, titanium oxide, silicon carbide, silicon nitride, boron carbide, boron nitride, zirconium diboride, nickel oxide, zinc oxide, zirconium oxide, strontium titanate, magnesium oxide, lithium lanthanum titanate, lithium lanthanum zirconate, lithium lanthanum tantalate, lithium cobalt oxide, lithium manganese oxide, lithium nickel manganese oxide and/or alumina, each with any doping additives and/or sintering additives as well as mixtures of various of these materials;
   (d) any metal; or/and
   (e) one or more materials from the group comprising: silver, lithium, palladium, platinum, gold, nickel, titanium, aluminum, copper, iron, niobium, chrome, vanadium, iridium, tantalum, osmium, rhenium, molybdenum, wolfram, magnesium or an alloy from various of these metals.
   (f) any non-metallic inorganic material, which predominantly has no crystalline structure and welches which is given its shape by means of a sintering process.
   (g) silicate fibers, borosilicate glass, and Tetrabor silicide.

The ceramic material may contain or consists of a material selected from the group consisting of TiO₂, BaTiO₃, YSZ, Li_{0.3}La_{0.7}TiO₃ and combinations of two or more of these.

Ceramics with preferred thicknesses are suitable for usual applications.

In one embodiment, the thickness of the ceramic starting material is preferably 20 mm or less, preferably 10 mm or less, preferably 5 mm or less, preferably 2 mm or less, preferably 1 mm or less, preferably 0.5 mm or less, preferably 0.05 mm or less. Optionally, the thickness is 0.001 mm or more, preferably 0.005 mm or more, preferably 0.01 mm or more, preferably 0.05 mm or more, preferably 0.1 mm or more. For example, the ceramics can have a thickness between 0.001 mm and 20 mm, in particular, between 0.005 mm and 15 mm, from 0.1 to 10.0 mm, from 0.2 to 8.0 mm, from 0.5 to 6.0 mm, or from 1.0 to 5.0 mm, for example from 2.0 to 4.0 mm.

In one embodiment, the ceramic product may comprise a membrane, in particular, a thin membrane. This membrane, in particular, thin membrane, may preferably have the above-specified thicknesses.

The ceramic product may have, in particular, a grain size gradient, a texture, a high temperature resistance, particularly homogeneous material properties, and/or a nano porosity.

The grain size may change in one direction, for example, by more than a factor of three in less than 50 μm, preferably, by more than a factor of five in less than 20 μm, most preferably, by more than a factor of 15 in less than 10 μm, and, at the same time, vary in an orthogonal direction by less than a factor of two. Preferably, the grain size may change gradually, in particular, as shown in FIG. 4, or in steps, in particular, as shown in FIG. 7. Preferably, the difference in grain size does not exceed a factor of 1000.

The porosity may transition, for example, in less than 5 μm from smaller than 5%, in particular, no open porosity, to larger than 15%, in particular, to open, percolating porosity.

The texture may be so significant that more than 15% of the grains are oriented at a deviation of less than 15°, preferably more than 20% of the grains at a deviation of less than 10° from a preferred axis.

The ceramic product of the invention may also be a multilayer composite, in particular, a multilayer composite including a plurality of layers.

The present invention also relates to a multilayer composite comprising or consisting of the ceramic product of the invention.

The present invention also relates to a capacitor comprising or consisting of the ceramic product of the invention.

The present invention also relates to a solid-state battery comprising or consisting of the ceramic product of the invention.

The present invention also relates to the use of the ceramic product of the invention as or in a capacitor or a solid-state battery.

### Experiments

The method according to the invention optionally allows for a very high density of dislocations. For classification purposes the following experiments were conducted by the inventors with the respectively specified results: (1.) Simple sintering of a ceramic cup led to a dislocation density of up to 10⁵/cm². (2.) Mechanical deformation led to a dislocation density of up to 10⁸/cm². (3.) Flash-sintering led to a dislocation density of up to 10¹⁰/cm². (4.) The proposed method is optionally capable of attaining dislocation densities in orders of magnitude of even larger than or equal to 10¹⁰/cm². The dislocation density can be improved by optimizing the temperature profile.

### SHORT DESCRIPTION OF THE FIGURES

Further features and advantages of the invention follow from the description, supra, in which preferred embodiments of the invention are illustrated by means of schematic drawings.

Hereby, it is shown in:

FIG. 1 a device according to the second aspect of the invention in a lateral view;

FIG. 2 a ceramic material used in the device of FIG. 1;

FIG. 3 a further device according to the second aspect of the invention in a perspective view;

FIG. 4 a light microscope receiving means of a ceramic product with a grain size gradient;

FIG. 5, 6, 7 an electron-microscopic receiving means of a ceramic product with a texture and leaping density gradient;

FIG. 8 representation of the quantification of the texture;

FIG. 9 an electron-microscopic receiving means of a ceramic product produced from two ceramic starting materials;

FIG. 10 an electron-microscopic receiving means of a multi-layer capacitor produced by means of the method according to the invention;

FIG. 11, 12 temperature-time-curves of the production of a ceramic product by means of the method of the invention.

FIG. 13 a further device according to the second aspect of the invention in a perspective view;

FIG. 14 transmission electron microscopy image of a ceramic product with nano pores.

FIG. 15 field dependent polarization curves for the ceramic product 43 and a reference sample 45

FIG. 16 atomic force microscope image of the ceramic product in piezo mode 47 and a reference sample 49

FIG. 17 atomic force microscope image of the ceramic product in piezo mode prior to precipitation

FIG. 18 atomic force microscope image of the ceramic product in piezo mode after precipitation

FIG. 19 atomic force microscope image of the ceramic product in piezo mode before 51 and after precipitation 55, as well as of a reference sample 53

FIG. 20 transmission electron microscopy image of a BaTiO₃ ceramics according to the invention.

### EXAMPLES

### Example 1: Green Body Made from Pressed SrTiO₃ Powder

A disc-shaped green body made from pressed SrTiO₃ powder of 99.99% purity is pressed with a thickness of 1 mm and a diameter of 6.4 mm at a pressure of 700 MPa. The starting particle size of the powder is approximately 400 nm. Subsequently, the green body is illuminated from one side, preferably, from above. The bottom side of the green body rests on a thin layer, for example, having a thickness of 1 cm to 2 cm, of highly porose alumina wool or, in the alternative, on a layer having a thickness of 1 cm or 2 cm of exfoliated graphite with a density von approximately 0.12 g/cm³.

By means of the illumination the green body is heated at a heating rate of 100 K/s to 500 K/s to the sintering temperature, 1875° C., or closely below or above the same, and maintained at this temperature for 25 seconds. Hereby, preferably, the temperature falls below or exceeds the sintering temperature by less than 15° C. Moreover, upon heating up the sintering temperature is stabilized preferably in less than 6 seconds. Thereafter the illumination is switched off and the green body is cooled down again to room temperature. Hereby, the cooling-off from the sintering temperature to less than 1000° C. happens in less than 3 seconds. For the illumination, preferably, a stack of laser diodes with a wavelength of 450 nm, a Xe flash lamp, halogen lamp, medium pressure UV emitter or infrared emitter is used. At sintering temperature, the power density is preferably 170 W/cm² when using a stack of laser diodes with a wavelength of 450 nm.

The dislocation density can, preferably, be checked using dark field transmission electron microscopy or electron channeling contrast imaging (ECCI).

### Example 2

A sheet made from the material BaTiO₃ is produces by means of tape casting. Hereby, the average particle size is less than or equal to 250 nm. First, the binding agent is burnt out. Temperature profiles requiring temperatures significantly below the sintering temperature, and oftentimes require time periods in a range of minutes to hours, are known in the state of the art relating to the respective binding agent. In the alternative to a conventional furnace, optionally, this step can also be carried out with the help of the radiation, whereby the power density is to be selected low, for example 80% lower. As soon as the binding agent is burnt out, the sheet is heated up by means of illumination to the sintering temperature. During illumination the sheet may, for example, float on a thin film above a reflecting surface or, in the alternative, on a layer of exfoliated graphite having a thickness of 1 cm, and be illuminated from above. In the alternative, it may be suspended vertically and be irradiated from two sides, whereby the power density must be applied from both sides. Hereby, the lateral dimensions are limited only by the size of the light source. In particular, the sheet may be moved in relation to the light source or the light source in relation to the sheet. This allows the temperature profile or, respectively, the power density to be additionally adjusted by the movement profile. Preferably, the relative movement of sheet and light source allows for processing a continuous band.

By means of the radiation at 400 K/s the sheet Folie is heated to the sintering temperature of 1150° C. to 1550° C. or closely below or above the same, and maintained at this temperature for 30 seconds. Hereby, preferably, the temperature falls below or exceeds the sintering temperature by less than 15° C. Moreover, upon heating up the sintering temperature is stabilized preferably in less than 6 seconds, for example, in less than 2 seconds. Thereafter the illumination is switched off and the green body is cooled down again to room temperature. Hereby, the cooling-off from the sintering temperature to less than 900° C. happens in less than 3 seconds. For the illumination, preferably, a stack of laser diodes with a wavelength of 450 nm, a Xe flash lamp, halogen lamp, medium pressure UV emitter or infrared emitter is used. At sintering temperature, the power density is preferably approximately 92 W/cm² when using a stack of laser diodes with a wavelength of 450 nm.

### Example 3

By means of laterally different thermal contacting with the support, a grain size gradient was created. Hereby, the radiation was homogeneous. In the alternative, the thermal contact with the support may be homogeneous while the radiation varies or, respectively, both the thermal contacting and the radiation may vary.

A green body was pressed from TiO₂ having 99.99% purity with a thickness or about 150 μm. This was placed on a copper support, whereby contact was established only at one small point or, respectively, at small points. This cooled these areas while the free-floating areas were subject to significantly less heat dissipation. In these areas the grain size is significantly larger with gradients towards the colder regions. The illumination was carried out using a stack of laser diodes with a wavelength of 450 nm at 200 W/cm² for 10 s.

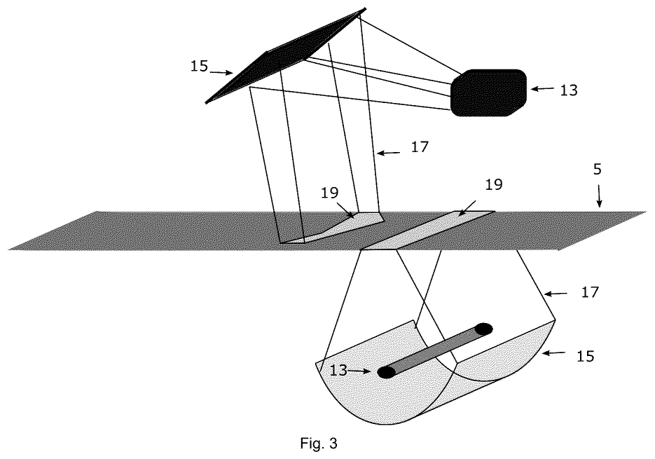

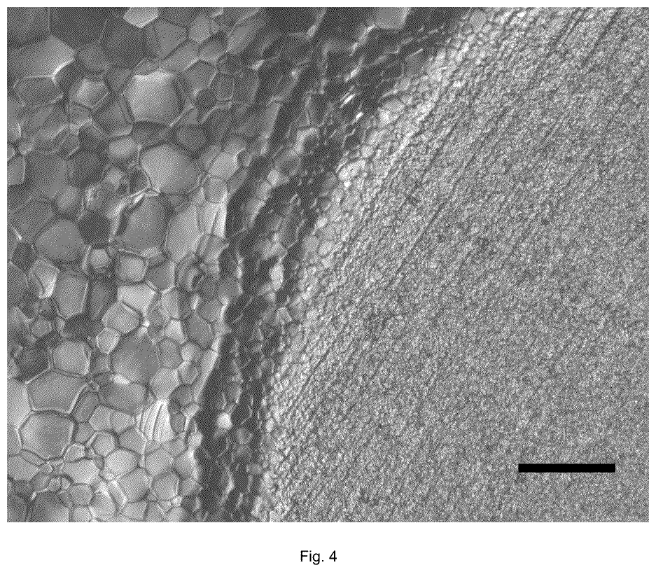

FIG. 4 shows a correspondingly produced ceramic product with a grain size gradient.

### Example 4

By virtue of different temperature profiles on the surface and inside the ceramics a grain size gradient and a texture were created. A green body was pressed from TiO₂ having 99.99% purity with a thickness or about 150 μm. The different temperature profiles were generated by a temporal power density profile with a first power density in a range of 4350 W/cm² for a time period of 20 ms, followed by a second power density in a range of 100 W/cm² for a period of 10 s. In the first illumination step no insulation was required because the temperature reached only the surface but not the volume. In the second illumination step a layer with a thickness of about 2 cm made of exfoliated graphite with a density of about 0.12 g/cm³ was used as insulating support.

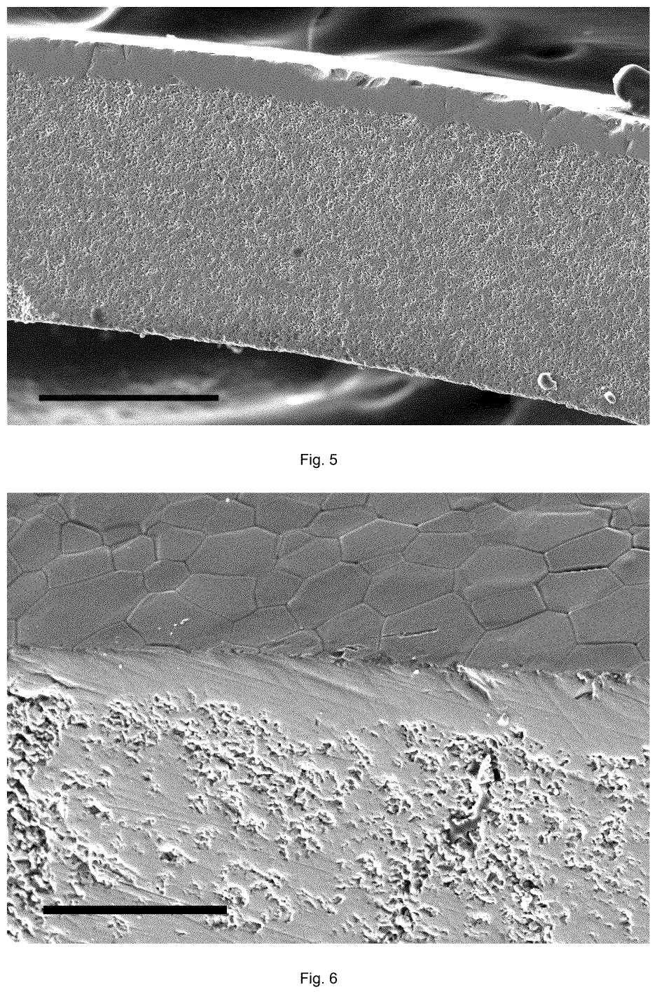

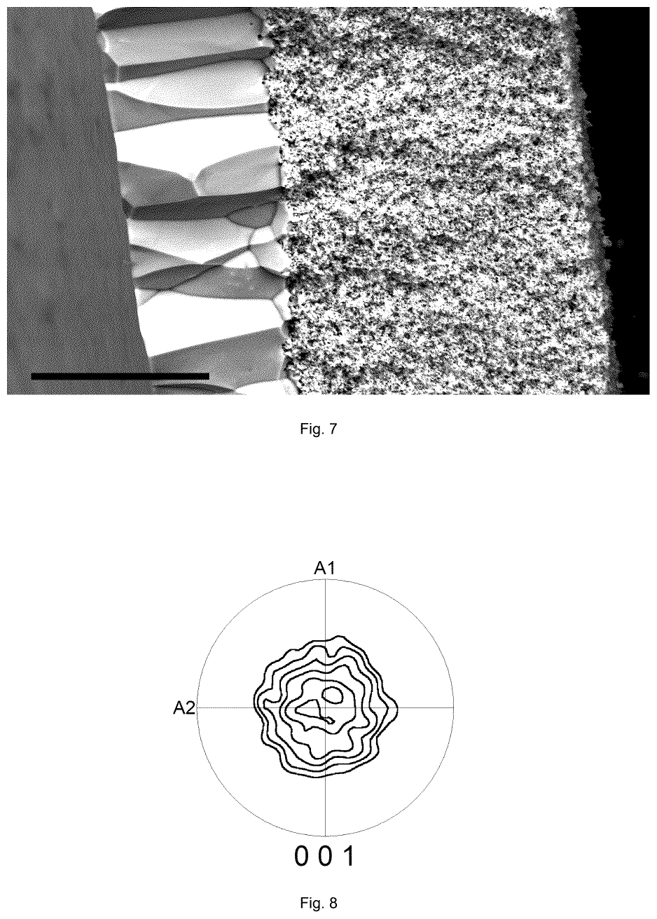

In this example, as shown in FIGS. 5, 6 and 7, what is created is a quasi-completely dense layer on the surface with a thickness of about 20 μm and a grain size of about 15 μm as well as a thicker layer lying underneath with significantly smaller grains and very high porosity. Hereby, FIG. 7, showing a surface of a break after the first processing step, shows that a large part of the grains extends across the entire thickness of the layer. Furthermore, the grains in this layer exhibit a preferred orientation that is referred to as texture. This texture was determined by means of electron diffraction, English: “electron backscatter diffraction,” for more than 5000 grains, and is shown and quantified in FIG. 8. In the alternative, the quantification may by expressed by a probability of a particular orientation region, which in this case was determined as 16% probability for an orientation with less than 15° deviation from the 100 axis.

Moreover, the second illumination step created, underneath the dense layer, a porose layer across the entire remaining thickness. This preferably exhibits and open porosity that is gas permeable, whereby the layer has mechanical integrity.

As particular feature is that this combination of a dense and a porose layer can be produced from a previously completely homogeneous green body. Furthermore, the short and intensive illumination step, in this case the first step, can be carried out during the longer and less intensive illumination step, making it possible to carry out the entire processing in one go and, for example, in 10 seconds or less.

### Example 5

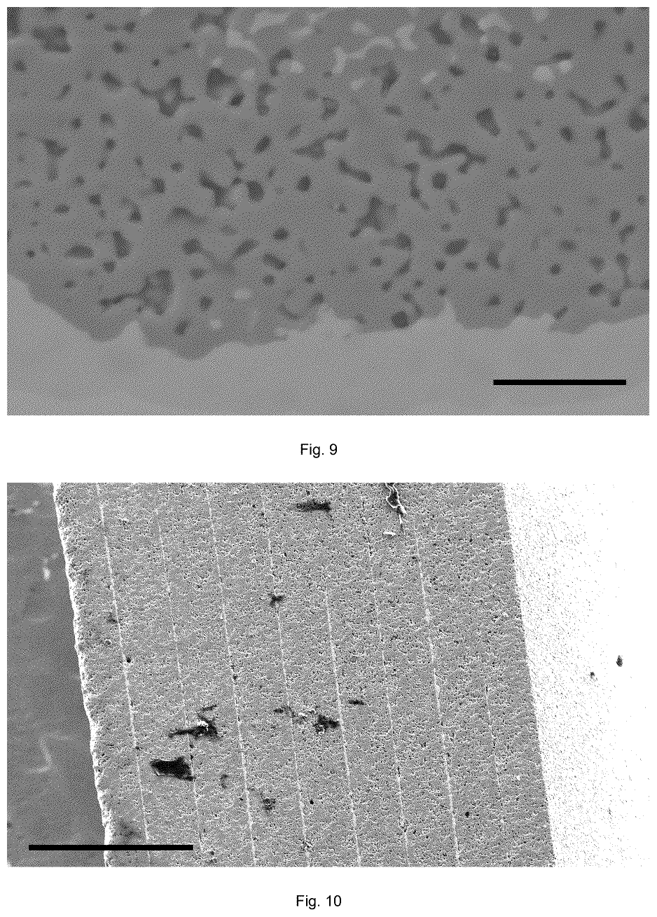

By means of the method of the invention, two ceramic starting materials, TiO₂ and BaTiO₃, which were pressed together in two layers as a powder, were sintered together to one ceramic product. A sharp boundary surface was attained. FIG. 9 shows a correspondingly generated ceramic product.

### Example 6

A multi-layer capacitor was produces by means of the method of the invention (see FIG. 10). The multi-layer capacitor consists of the ceramics BaTiO₃ and thin layers of platinum electrodes. The layers of BaTiO₃ were produced by means of tape casting, whereby the platinum electrodes were manufacture by means of silk screening (English: “screen printing”). The binding materials required for the für tape casting were burnt out in a conventional furnace at average temperature. Thereafter, the raw component was place on an insulation made of exfoliated graphite having a thickness of about 2 cm and illuminated from above. The power density was 47 W/cm² for 5 seconds followed by 75 W/cm² for 20 seconds followed by 47 W/cm² for a further 10 seconds.

FIG. 10 shows a polished cross-section through the thickness of the component.

### Example 7

The Example 7 relates to various temperature-time progressions of manufacturing a ceramic product using the method of the invention.

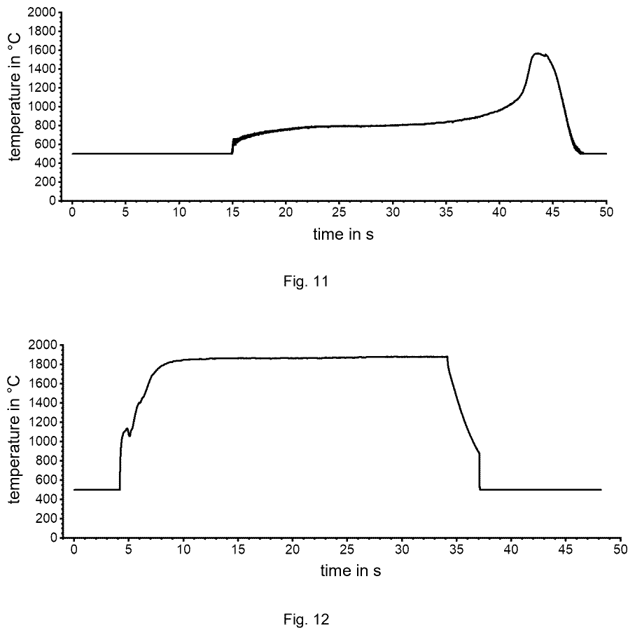

FIG. 11 shows the temperature dependence of the absorption of the irradiated light. At high temperatures, longer wavelengths are absorbed to a larger extent. The temporal progression of the temperature shows that, initially, at a temperature about 800° C., there appears nearly a temperature plateau with a marked slowdown of the temperature increase. As soon as a tipping point above 800° C. was reached, a massive temperature increase up to nearly 1600° C. occurred. At temperatures below the tipping point there is relatively little absorption of the light by the material. Above 800° C. the irradiated light is absorbed significantly better. This Example was made with pressed powder with a thickness of 1 mm made of lithium ion conducting Li_{6.4}La₃Zr_{1.4}Ta_{0.6}O₁₂ ceramics.

FIG. 12, however, shows the temperature-time progression of a sample with without notable temperature dependence of the absorption of the irradiated light. This temperature curve was recorded in the experiment in Example 1.

### Example 8

A disc-shaped green body made from TiO₂ powder of 99.99% purity is pressed with a thickness of 1 mm and a diameter of 6.4 mm at a pressure of 700 MPa. The starting particle size of the powder is approximately 300 nm. Subsequently, the green body is illuminated from one side, preferably, from above. The bottom side of the green body rests on a thin layer, for example, having a thickness of 1 cm to 2 cm, of highly porose alumina wool or, in the alternative, on a layer having a thickness of 1 cm or 2 cm of exfoliated graphite with a density von approximately 0.12 g/cm³.

By means of the illumination the green body is heated at a heating rate of 100 K/s to 500 K/s to the sintering temperature, 1875° C., or closely below or above the same, and maintained at this temperature for 10 to 30 seconds. Hereby, preferably, the temperature falls below or exceeds the sintering temperature by less than 15° C. Moreover, upon heating up the sintering temperature is stabilized preferably in less than 6 seconds. Thereafter the illumination is switched off and the green body is cooled down again to room temperature. Hereby, the cooling-off from the sintering temperature to less than 1000° C. happens in less than 3 seconds. For the illumination, preferably, a stack of laser diodes with a wavelength of 450 nm, a Xe flash lamp, halogen lamp, medium pressure UV emitter or infrared emitter is used. At sintering temperature, the power density is preferably 115 to 135 W/cm² W/cm² when using a stack of laser diodes with a wavelength of 450 nm.

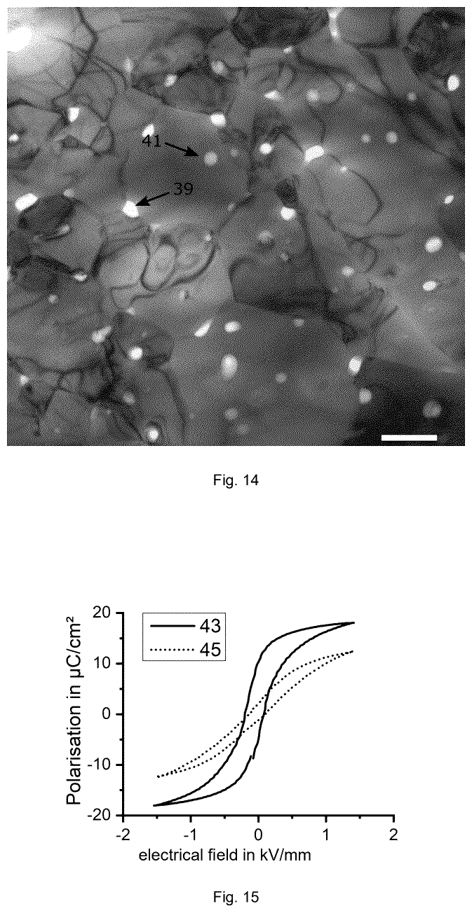

The nano-porosity can, preferably, be checked using transmission electron microscopy or in a micrograph section of a polished surface in a scanning electron microscope. FIG. 14 shows a transmission microscopy image in which nano pores are visible and some of them are marked. Hereby, reference numeral 39 marks a pore which extends across the entire observed sample thickness. The observed total number of pores cannot be smaller than the number of this type of pores. Hereby, reference numeral 41 marks a pore which extends only across a part of the observed sample thickness.

### Example 9

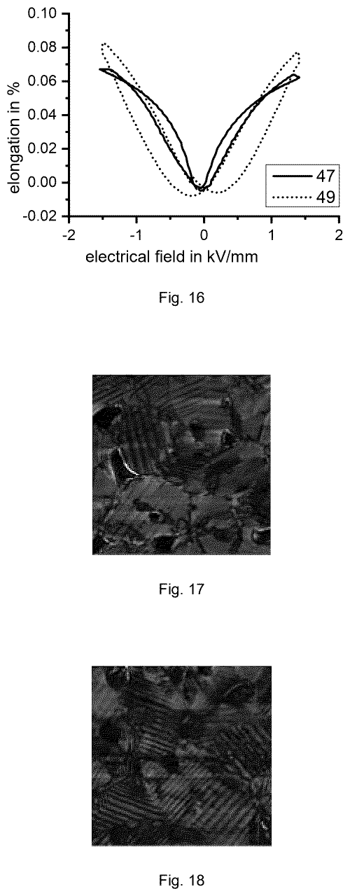

Ferroelectric characteristics from FIGS. 15 and 16.

BaTiO₃ powder was calcined using conventional solid-body synthesis from stoichiometrically weighed TiO₂ (99.9%) and BaCO₃ (99.95%) at 885° C. for 4 hours. The raw materials had been grinded before, using an attritor mill, and afterwards, using a planetary mill. The samples were pressed as described in connection with Example 8 and, subsequently, the reference sample was sintered in oxygen at 1220° C. for 5 hours at a heating and cooling rate of 10 Kelvin per minute. The other sample was irradiated in accordance with the described method using a xenon flash light with a power density of less than 800 W/cm² for 15 s. The hysteresis curves of polarization and expansion were measured in parallel using a measuring circuit according to Sawyer and Tower for the polarization and an optical position sensor for the expansion. In addition, the measurement was carried our bipolar up to a field strength of 1.5 kV/mm or, respectively, −1.5 kV/mm. The FIGS. 15 and 16 were measured at a frequency of 100 Hz. The continuous lines, marked with the reference numerals 43 and 47, represent the measured polarization and expansion of the sample sintered using the xenon flash light, the reference numerals 45 and 49 represent those of the reference sample.

### Example 10

Influence on the domain structure from FIGS. 17-19.

For Example 10, one reference sample each was sintered conventionally and one sample using the xenon flash light. The ceramics according to the invention was post-treated in a precipitation step at 800° C., whereby the heating and cooling rates were 5 K/min. All other synthesis parameters may be seen from Examples 8 and 9. Subsequently the samples were polished using diamond paste of the particle size 15 μm, 6 μm, 3 μm, 1 μm and 0.25 μm and thereafter vibration polished for several hours.

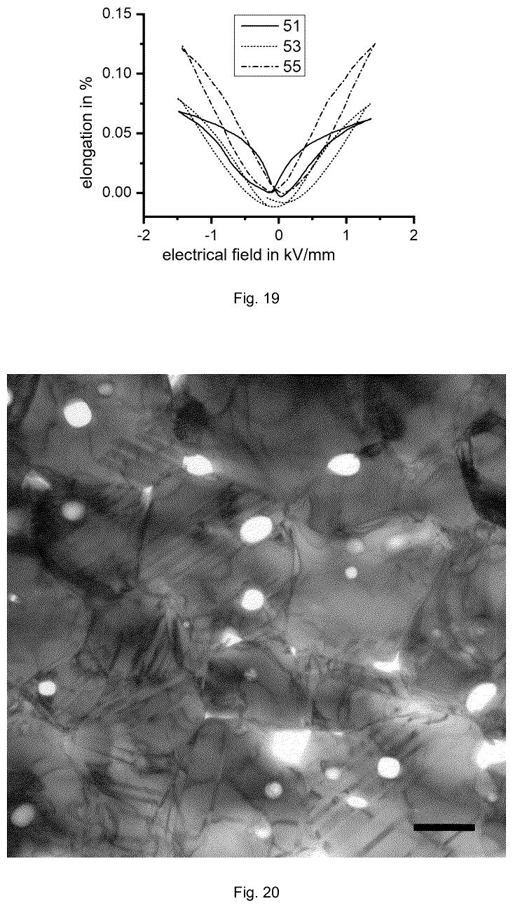

In BaTiO₃ two types of domains appear, the 90° and the 180° domains. Both are visible in FIG. 17. It is noticeable, though, that the distances of the domain walls of the original sample, compared to the precipitated one, at 800° C., are significantly smaller. It is to be assumed that the larger domain wall density changes many ferro and dielectric properties. For example, is can be assumed that the increased domain wall density may contribute to the expansion in FIG. 19.

In the alternative, a domain structure may also be visualized using transmission electron microscopy, as shown in FIG. 20.

### DETAILED DESCRIPTION OF THE FIGURES

FIG. 1 shows a device 1.

The device 1 comprises a receiving means 3 which receives a powdery ceramic starting material 5. In this case, the receiving means 3 is a support on which the ceramic material 5 rests. The ceramic material 5 is a cuboid or film-like green body.

Moreover, the device 1 comprises a light source 7. The light source 7 is a halogen lamp that emits light in the infrared wavelength range.

The device 1 is configured to carry out the method according to the first aspect of the invention.

To that end, light 9 from the light source 7 is radiated onto a surface area 11a of the ceramic material 5. This heats up and sinters the material of the surface area 11a and the volume area lying underneath. Hereby, the heating up happens so quickly, i.e., at such a high heating rate, that, optionally, a high local density of dislocations can be created in the ceramic product which is obtained after sintering. Thus, the optional locally created dislocations exist in the heated area.

Subsequently, the irradiation of light is changed so that the Licht 9 from the light source 7 is radiated onto a surface area 11b of the ceramic material 5 and, correspondingly, in this area too, the ceramic material 5 is sintered and optionally a high dislocation density is created. The changing of the radiation of light happens, for example, by means of a monitoring and control unit, not shown in FIG. 1, which may comprise one or more sensors, such as temperature sensors and optical sensors.

Subsequently, the ceramic material 5 can be removed in the form of the then produced ceramic product.

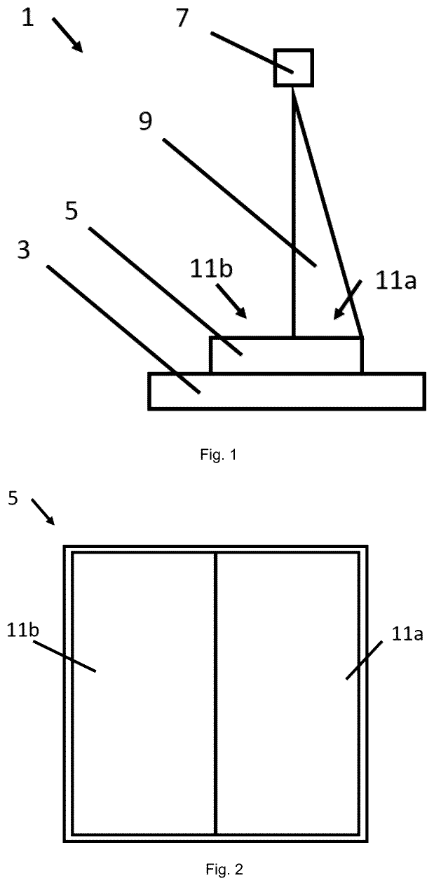

FIG. 2 shows a top view on the ceramic material 5 received in the receiving means 3 (not shown in FIG. 2). The two surface areas 11a and 11b are drawn therein, whereby, for better recognizability, they are shown spaced apart from the edge of the pellet 5. Thus, the ceramic material 5 is heated by irradiation of light, sequentially, first in the surface area 11a and then in the area 11b (to be exact, of course, primarily the volume area of the material lying underneath). While, in this case, the irradiation of light transitions, so to speak, from the surface area 11a to the surface area 11b, other ways of realization are also possible.

For example, light may be radiated simultaneously onto the surface areas 11a and 11b. Be that in that a second light source is utilized or that the light from the light source 7 is widened.

Also, for example, the green body 5 could be moved continuously relative to the light cone 9. In that case, the green body 5 could be moved, relatively seen, into the light cone 9 and, as a result, after a certain amount of time, be illuminated in the surface area 11a. While the relative movement continues, the green body 5 could be illuminated in the surface area 11b after a certain amount of time and, subsequently, the green body 5 could be moved, relatively seen, out of the light cone 9 again.

FIG. 3 shows an embodiment of a device according to the second aspect of the invention, wherein a ceramic material 5 in film form is moved relative to the illumination. In particular, the ceramic material 5 may be used in the form of an endless band, whereby the ceramic material 5 may also be a multilayer composite.

On one or two sides, light sources 13 of the same or (as provided in FIG. 3) different types may be installed. The light is guided towards the ceramic material 5 by means of optics 15 suited for the respective light source 13. Hereby, in FIG. 3, the beam path 17 as well as the illuminated zone 19 are shown schematically.

Hereby, the temperature profile is individually controlled by the design of the respectively illuminated zone 19, the temporal variation of the intensity and by the relative movement of the beam path 17 or, respectively, the light source 13 and the ceramic material. Furthermore, the temperature profile may be optimized by utilizing a plurality of illuminated zones that may also be used overlappingly.

FIG. 4 shows an electron microscopic image of a ceramic product with a grain size gradient. On the left side large grain sizes with a diameter in a range of 100 μm can be seen. On the right side significantly smaller grain sizes can be seen. The scale dimension bar is approximately 250 μm.

The FIGS. 5 and 6 show electron microscopic images of a ceramic product with a stepped density gradient. Underneath a dense surface layer there is a porose volume. The scale dimension bar is 100 μm in FIG. 5 and 50 μm in FIG. 6.

FIG. 7 shows an electron microscopic image of a ceramic product in which only the surface was treated, which represents a precursor to the ceramic product in FIGS. 5 and 6. What is shown is a surface of a break. Herein, it becomes apparent that the grains of the dense layer extend throughout the entire layer thickness.

FIG. 8 shows a quantization of the texture of titanium dioxide, which is also represented in FIGS. 5 and 6. What is shown is the probability that the crystal structure of the grains is oriented in a certain direction. In the center of the circle lies the. On the edges of the circle the orientation differs by 90° from the direction 100, whereby two orthogonal directions A1 and A2 are drawn. The black lines each define areas in which a certain probability of orientation exists. The lines each represent numeral values of multiples of a statistical probability (English: “times random”). From the outside towards the inside the values for the lines are 0.71; 1; 1.41; 2; 2.83, and 4.

FIG. 9 shows an electron microscopic image of a ceramic product produced from two ceramic starting materials. A sharp delineation can be seen. The scale dimension bar is 5 μm.

FIG. 10 shows an electron microscopic image of a multi-layer capacitor produced by means of the method of the invention. Metal conductor structures can be seen in-between ceramic parts. The scale dimension bar is 200 μm.

The FIGS. 5 and 6 show temperature-time curves of the production of a ceramic product by means of the method of the invention. By means of the arrangement used for measuring the temperature, consisting of a pyrometer for the temperature range from 500° C. to 3000° C. no temperatures below 500° C. could be detected. Thus, the curves always show a value of 500° C. for temperatures of ≤500° C.

The features disclosed in the above description, in the claims, and in the drawings may be essential, each on their own as well as in any combination thereof, for the invention in its various embodiments.

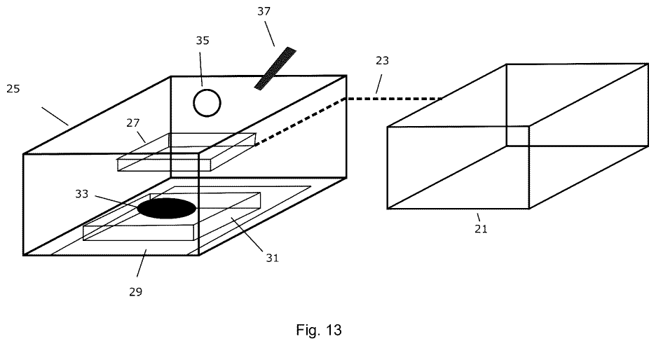

FIG. 13 shows a device according to the second aspect of the invention.

The device comprises an electricity supply, an intermediate energy storage means, control technology, and a water-cooling system, which can be accommodated in a housing 21. This can be connected by means of cables and tubes to a further, light shielding housing 25, in which light emitting diodes and the ceramic material are located.

The light emitting diodes 27 are arranged as densely as possible and, in addition to the power supply, connected to a water-cooled thermal sink. The arrangement of the light emitting diodes 27 is mounted via a device for easy replacement of the ceramic materials 29. This consists of an exchangeable insulation 31 onto which the ceramic material 33 can be placed.

The housing 25 may be provided with a cooling system 35 by means of, for example, a ventilator. Moreover, the device may be provided with a pyrometer 37 which can read out the temperature of the surface of the ceramics.

FIG. 14 shows a suitable transmission microscopy image of TiO₂ produced according to the invention, with nano pores, as described in Example 8. On the image, nano pores 39 and 41 are marked as examples. A nano pore 39 may extend across the entire observable sample thickness. In the alternative, a nano pore 41 may cover only a part of the sample thickness. The scale dimension bar is 2 μm.

FIG. 15 shows a hysteresis curve of the polarization as a function of the electric field for the ceramic product 43 according to the invention, in this case BaTiO₃, and a reference sample 45, likewise BaTiO₃.

FIG. 16 shows a hysteresis curve of the expansion as a function of the electric field for the ceramic product 43 according to the invention, in this case BaTiO₃, and a reference sample 45, likewise BaTiO₃.

FIG. 17 shows an atomic force microscopy image in piezo mode of a ceramics according to the invention which was produced with a precipitation step. The length of one side of the square images is 10 μm. The contrast is generated by the deflection of a conductive tip of the atomic force microscope. By applying alternating current, the inverse piezo-electric effect is used to depict the domain structure.

FIG. 18 shows an atomic force microscopy image in piezo mode of a BaTiO₃ ceramics according to the invention after a precipitation step.

FIG. 19 shows, similar to FIG. 16, a hysteresis curve of the expansion as a function of the electric field for the ceramic product according to the invention, in this case BaTiO₃, without precipitation step 51 as well as after a precipitation step 55, and a reference sample 53, also BaTiO₃.

FIG. 20 shows a transmission electron microscopy image of a BaTiO₃ ceramics according to the invention, as described in Example 9. Both nano porosity and domains can be seen.

List of reference numerals

| | |
|---|---|
| 1 | device |
| 3 | receiving means |
| 5 | ceramic material |
| 7 | light source |
| 9 | light |
| 11a, 11b | surface area |
| 13 | light source |
| 15 | optics |
| 17 | beam path |
| 19 | illuminated zone |
| 21 | housing for power supply, intermediate energy storage means, |
| | control technology and water cooling. |
| 23 | connection for cables and tubes |
| 25 | light shielding housing |
| 27 | arrangement of light emitting diodes with water cooled |
| | thermal sink |
| 29 | device for simple exchanging the ceramic material and |
| | insulation |
| 31 | replaceable insulation |
| 33 | ceramic material |
| 35 | cooling |
| 37 | pyrometer |
| 39, 41 | nano pores |
| 43 | polarization light sintered sample |
| 45 | polarization reference sample |
| 47 | expansion light sintered sample |
| 49 | expansion reference sample |
| 51 | expansion prior to precipitation |
| 53 | expansion reference |
| 55 | expansion after precipitation |

1. Method for producing ceramics, the method comprising:
radiating light onto a ceramic starting material in order to heat this at least in some regions and, as a result, to produce a ceramic product,
wherein the radiation of light is carried out simultaneously onto a surface of at least 20% of the surface of the ceramic starting material,
wherein the power density of the radiated light is between 10 W/cm² and 750 W/cm², further preferably, between 20 W/cm² and 200 W/cm²,
wherein the light includes wavelengths in a range from 200 to 700 nm, further preferably, from 300 to 500 nm, and
wherein the ceramic starting material is thermally decoupled in relation to a receiving means by means of an insulation.

2. Method according to claim 1, wherein the heating of the ceramic starting material in some regions happens at a heating rate of
(a) 1 K/s or more, preferably 10 K/s or more, preferably 100 K/s or more, preferably 1000 K/s or more, and/or
(b) 10000 K/s or less, preferably 5000 K/s or less, preferably 1000 K/s or less and/or.

3. Method according to claim 1, wherein the heating, in particular, in some regions, of the ceramic starting material is carried out by radiating light for a time period of
(a) at least 0.1 seconds, at least 0.5 seconds, at least 1 second, preferably at least 5 seconds, preferably at least 20 seconds, and/or
(b) at most 10 minutes, preferably at most 8 minutes, preferably at most 5 minutes, preferably at most 3 minutes, preferably at most 1 minute, preferably at most 30 seconds, preferably at most 10 seconds, preferably at most 5 seconds, preferably at most 3 seconds, preferably at most 1 second.

4. Method according to claim 1,
wherein the ceramic starting material is free of absorbing additives.

5. (canceled)

6. Method according to claim 1, wherein the ceramic starting material comprises at least one ceramic multilayer composite, at least one ceramic composite material and/or at least one ceramic powder, and/or is provided in the form of a sheet, an endless tape, a, preferably cuboid, pellet and/or as a solid body.

7. Method according to claim 1,
(i) wherein the thickness of the ceramic starting material is between 0.00005 mm and 20 mm, preferably between 0.001 mm and 10 mm, preferably between 0.1 mm and 5 mm, preferably between 0.5 mm and 4.0 mm,
(ii) wherein the ceramic starting material includes or consists of SrTiO₃, and/or TiO₂ as material and/or wherein the ceramic product comprises or constitutes a ceramic membrane; and/or
(iii) wherein the ceramic starting material includes one or more of the following materials:
(a) any ceramic material, in particular, a non-metallic inorganic material with a crystalline structure;
(b) a ceramics with a perovskite structure, spinel structure, sphalerite structure, wurtzite structure, sodium chloride structure, or fluoride structure;
(c) a ceramics on the basis of barium titanate, barium zirconate, lead zirconate titanate, titanium oxide, silicon carbide, silicon nitride, boron carbide, boron nitride, zirconium diboride, nickel oxide, zinc oxide, zirconium oxide, strontium titanate, magnesium oxide, lithium lanthanum titanate, lithium lanthanum zirconate, lithium lanthanum tantalate, lithium cobalt oxide, lithium manganese oxide, lithium nickel manganese oxide and/or alumina, each with any doping additives and/or sintering additives as well as mixtures of various of these materials;
(d) any metal;
(e) one or more materials from the group comprising: silver, lithium, palladium, platinum, gold, nickel, titanium, aluminum, copper, iron, niobium, chrome, vanadium, iridium, tantalum, osmium, rhenium, molybdenum, wolfram, magnesium or an alloy from various of these metals;
(f) any non-metallic inorganic material, which predominantly has no crystalline structure and welches which is given its shape by means of a sintering process;
(g) one or more materials from the group comprising: silicate fibers, borosilicate glass, and Tetrabor silicide.

8. Method according to claim 1, wherein the light completely illuminates at least one surface, in particular, side, preferably, main side, of the ceramic starting material.

9. Method according to claim 1,
(i) wherein the geometry defined by the radiation in a heated zone is created, in particular, with a large surface, which is square or the shape of which can be freely selected by the user;
(ii) wherein the irradiation is reduced by more than 90% with a delay of less than 10 seconds, preferably, in less than 1 second, further preferably, in less than 0.1 second, preferably less than 0.01 second, further preferably, less than 1 millisecond, even further preferably, less than 0.1 millisecond, and/or wherein by switching off the radiation a cooling rate of more than 10 K/s, further preferably, more than 50 K/s, even further preferably, more than 200K/S is attained; and/or
(iii) wherein the temperature profile can be controlled to be locally or/and temporally varying.

10. Method according to claim 1, wherein the light
(i) exclusively consists of wavelengths in the range from 200 to 700 nm,
(ii) is emitted from at least one light source including, in particular, at least one light emitting diode, at least one laser, Xe flash light, at least one halogen lamp, at least one UV light, at least one medium pressure UV emitter and/or at least one metal halide lamp, at least one infrared emitter,
(iii) is guided by an optics onto the ceramic starting material and/or, preferably, focused onto the area to be heated, and/or
(iv) warms up the ceramic starting material on the surface and/or within a volume area adjacent to the surface.

11. (canceled)

12. Method according to claim 1, the method additionally including a further radiating of light, the further radiating of light being carried out at a power density of at least 1500 W/cm² and a time period of at most 50 ms.

13. Method according to claim 1, wo the method including a precipitating step in which the ceramic product is being maintained at a temperature in a range between 300° C. and 1000° C. for a time period of at least 10 s.

14. Method according to claim 1, wherein the cooling-off rate in the temperature range from 800° C. to 100° C. across a span of at least 100 K is at most 1 Kelvin per second.

15. Device, designed to carry out the method according to claim 1, the device comprising
at least one receiving means for receiving a ceramic starting material and
at least one light source for radiating light onto the ceramic starting material that is or can be received in the receiving means,
wherein, preferably, the device is configured to radiate the light onto the ceramic starting material in order to heat this at least in some regions and, as a result, to produce a ceramic product, and wherein the receiving means has an insulation.

16. Device according to claim 15, wherein the heat conductivity of the insulation at 1400° C. is at most 10 W/(m*K).

17. Device according to claim 15,
a. in which the light emitting diodes are mounted on a thermal side and optional provided with micro lenses and/or lenses, in particular, to illuminate a ceramic material in a manageable housing which protects the environment from the light employed,
b. in which the light output can reach at least 10 W/cm²,
c. in which the machining area is designed modular and/or provided with an exchangeable insulation and/or the temperature can be read out by means of a pyrometer and/or the light sources are separated from the ceramic material by a quartz glass window, and/or
d. in which a stack of laser diodes is utilized in addition or as an alternative to the array of light emitting diodes.

18-20. (canceled)

21. Device according to claim 15, wherein the insulation comprises a gas film.

22-29. (canceled)
